(19) United States
(12) Patent Application Publication
(10) Pub. No.: US 2007/0238265 A1
(43) Pub. Date: Oct. 11, 2007

(54) Plating apparatus and plating method

(76) Inventors: Keiichi Kurashina, Tokyo (JP); Tsutomu Nakada, Tokyo (JP); Takashi Kawakami, Tokyo (JP); Satoru Yamamoto, Tokyo (JP); Keisuke Hayabusa, Fujisawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/396,572

(22) Filed: Apr. 4, 2006

(30) Foreign Application Priority Data
Apr. 5, 2005 (JP) 2005-108408
Jun. 28, 2005 (JP) 2005-188311
Aug. 10, 2005 (JP) 2005-232118
Jan. 13, 2006 (JP) 2006-6077

(51) Int. Cl. C25D 3/00; B05C 9/08; B32B 15/04

(52) U.S. Cl. 438/470; 118/620; 204/194; 204/450

(57) ABSTRACT

A plating apparatus can form a plated film having a more uniform thickness over an entire surface of a substrate and can securely fill interconnect recesses with the metal without forming voids in the embedded metal even when the substrate has a high sheet resistance in the surface. The plating apparatus includes a substrate holder for holding a substrate, a cathode portion including a cathode for contact with the substrate held by the substrate holder to feed electricity to the substrate, and an anode, partly or wholly having a high resistance, disposed opposite a surface of the substrate held by the substrate holder, wherein plating of the surface of the substrate is carried out while filling between the anode and the substrate held by the substrate holder with a plating solution.

### BACKGROUND OF THE INVENTION

1. Field of the Invention

The present invention relates to a plating apparatus and a plating method, and more particularly to a plating apparatus and a plating method used for filling fine interconnect recesses (circuit pattern) formed in a substrate, such as a semiconductor substrate, with metal (interconnect material) such as copper so as to form interconnects.

The present invention also relates to an electrolytic processing apparatus and an electrolytic processing method used for electrolytic processing such as electroplating.

2. Description of the Related Art

In recent years, instead of using aluminum or aluminum alloys as a material for forming interconnect circuits on a semiconductor substrate, there is an eminent movement towards using copper that has a low electric resistivity and high electromigration resistance. Such copper interconnects are generally formed by filling copper into fine interconnect recesses formed in a surface of a substrate. Various techniques for forming such copper interconnects are known, including CVD, sputtering, and plating. According to any such techniques, a copper film is formed in the substantially entire surface of a substrate, followed by removal of unnecessary copper by performing chemical mechanical polishing (CMP).

FIGS. 1A through 1C illustrate, in sequence of process steps, an example of forming such a substrate W having copper interconnects. First, as shown in FIG. 1A, an insulating film 2, such as an oxide film of SiO₂ or a film of low-k material, is deposited on a conductive layer 1a in which semiconductor devices are formed, which is formed on a semiconductor base 1. Contact holes 3 and interconnect trenches 4 as interconnect recesses are formed in the insulating film 2 by the lithography/etching technique. Thereafter, a barrier layer 5 of TaN or the like is formed on the surface, and a seed layer 7 as an electric supply layer for electroplating is formed on the barrier layer 5 by sputtering, or CVD, or the like.

Then, as shown in FIG. 1B, copper plating is performed onto a surface of the seed layer 7 of the substrate W to fill the contact holes 3 and the trenches 4 with copper and, at the same time, deposit a copper film 6 on the insulating film 2. Thereafter, the copper film 6, the seed layer 7 and the barrier layer 5 on the insulating film 2 are removed by chemical mechanical polishing (CMP) so as to make the surface of the copper film 6 filled in the contact holes 3 and the trenches 4, and the surface of the insulating film 2 lie substantially on the same plane. Interconnects composed of the copper film 6 are thus formed in the insulating film 2, as shown in FIG. 1C.

In recent years, more and more fine interconnects are formed in copper interconnects forming process for semiconductor devices, and design rules for such fine interconnects are considered to be changing from the 0.18 μm generation to the 0.13 μm generation and further to the 0.10 μm generation. Depending on circumstances, the advent of the seed-layer-less generation of semiconductor devices may not be impossible. With those more and more fine interconnects, unless a thickness of the seed layer is further reduced, the seed layer overhangs at the inlets of interconnect recesses, tending to produce voids in the plating process. In the 0.18 μm generation of design rules, the thickness of the seed layer is generally in the range from about 150 to 200 nm on the flat surface of the substrate. In the 0.13 μm generation of design rules, the thickness of the seed layer is about 50 nm in order to prevent voids from being produced in the plating process. In the 0.18 μm generation of design rules, the thickness of the seed layer will possibly be reduced to a range from about 5 to 25 nm.

When carrying out copper electroplating on a surface of a seed layer formed in a substrate, an anode of a low (almost zero) resistance is employed, and a plating current is passed between the anode and the seed layer while keeping the peripheral region of the seed layer in contact with an electrode (electrical contact) to feed electricity to the seed layer. Therefore, the thinner the seed layer is, the higher is the sheet resistance of the seed layer immediately after initiation of plating, and the plating current is more likely to concentrate in the peripheral region of the seed layer.

In particular, when a current circuit is considered in which an electric current fed from a power source to the anode flows through a plating solution to the surface (surface to be plated), i.e., the seed layer, of the substrate, only the resistance of the plating solution exits in a current pathway to the peripheral region of the seed layer where there are feeding points. In a current pathway to the center of the seed layer, on the other hand, the electric resistance of the seed layer itself from its center to the peripheral region in which the feeding points are present, i.e., the sheet resistance of the seed layer, also exits in addition to the resistance of the plating solution. As a thickness of a seed layer, formed in a pre-plating step, becomes thinner with finer circuit patters formed on a substrate, the electric resistance (sheet resistance) of seed layer becomes larger. This produces a larger difference in resistance between a current pathway running through the center of a substrate and a current pathway running through the peripheral region of the substrate, thus decreasing an electric current passing the center of the substrate. Thus, the amount of plating becomes increasingly larger in the peripheral region of a substrate, whereas the amount of plating is increasingly smaller around the substrate center distant from feeding points. The effect of the electric resistance, which increases with distance from a feeding point, is called “terminal effect”.

Conventionally, in order to improve the unevenness of a thickness of a plated film due to the terminal effect, it has been practiced to interpose a doughnut-shaped shielding plate between an anode and a surface of a substrate so that an electric current more easily flows to the center of the substrate. It is also practiced to provide a dummy to-be-plated electrode, called thief electrode, outside a substrate to disperse electricity passing in the peripheral region of the substrate, thereby decreasing the amount of plating in the peripheral region of the substrate. A method has also been practiced which involves inserting a porous structure between an anode and a substrate to increase the resistance of the plating solution so as to make the effect of the sheet resistance of the surface (surface to be plated) of the substrate relatively small, thus reducing the terminal effect.

The applicant has proposed a plating apparatus wherein a plating power source is connected individually to a plurality of split anodes to increase a current density at those split anodes positioned in a central area of the substrate to a level higher than at those split anodes positioned in a peripheral area of the substrate only during a certain period of time in which an initial plated film is formed on the substrate, thereby preventing the plating current from concentrating on the outer circumferential portion of the substrate, but allowing the plating current to flow to the central area of the substrate to make it possible to form a uniform plated film even if the sheet resistance is high (for example, see Japanese laid-open patent publication No. 2002-129383).

By using a low-k material, which has a high dielectric constant, for an insulating film in which interconnects are to be formed, the reliability of fine interconnects can be enhanced. Low-k materials, however, generally have low mechanical strength. Accordingly, when filling trenches, formed in an insulating film of a low-k material, with copper by plating, and then removing unnecessary copper on the insulating film by CMP processing, dishing is likely to occur in the surface of the insulating film. Suppression of dishing in CMP makes complete removal of unnecessary copper difficult. There is, therefore, a demand for the formation of such a plated film that can reduce the burden on a CMP processing as much as possible by plating.

When carrying out plating of a surface of a substrate, as shown in FIG. 2, a cathode 200 is connected to an peripheral region of an conductive layer, such as a seed layer 7, formed on a surface of a substrate W, and a plating solution 204 is filled into between the substrate W and an anode 202 disposed opposite the substrate W. A plated film is deposited on the conductive layer of the substrate W by passing a plating current between the anode 200 and the cathode 202 from a power source 206.

Semiconductor wafers and liquid crystal substrates for LSI's tend to increase in area year by year. In line with this tendency, the substrates are posing problems. In detail, as the area of the substrate W increases, the electric resistance (sheet resistance) of the conductive layer, such as a seed layer 7, ranging from the cathode 200 on the periphery of the substrate W to the center of the substrate W also increases. As a result, a potential difference produces in the surface of the substrate W, causing a difference in the plating rate. FIG. 2 is an electrical equivalent circuit diagram of general electroplating, and the following resistance components exist in this circuit:

R1: Power source wire resistance between power source 206 and anode 202, and various contact resistances

R2: Polarization resistance at anode 202

R3: Resistance of plating solution 204

R4: Polarization resistance at cathode 200

R5: Resistance of conductive layer (sheet resistance)

R6: Power source wire resistance between cathode 200 and power source 206, and various contact resistances

As shown in FIG. 2, when the resistance R5 of the conductive layer becomes higher than the other electric resistances R1 to R4 and R6, the potential difference arising between both ends of this resistance R5 of the conductive layer increases, and accordingly, a difference occurs in the plating current. Thus, the plated film growth rate lowers at a position distant from the cathode 200. If the film thickness of the conductive layer is small, the resistance R5 further increases, and this phenomenon appears conspicuously. This fact means that the current density differs in-plane of the substrate W, and the characteristics of a plated film itself (resistivity, purity, burial characteristics, etc. of the plated film) are not uniform in-plane.

Even in electrolytic etching in which the substrate is an anode, the same problems occur, merely with the direction of electric current being reversed. In a manufacturing process for a large-diameter wafer, for example, the etching rate at the center of the wafer slows compared with the peripheral edge portion.

As a method for avoiding these problems, it is conceivable to increase the thickness of the conductive layer or decrease the electric conductivity of the conductive layer. However, the substrate is subject to various restrictions even in manufacturing steps other than plating. For example, when a thick conductive layer is formed on a fine pattern by sputtering, voids easily occur inside the pattern. Thus, it is impossible to easily increase the thickness of the conductive layer or change the film type of the conductive layer.

In order to solve above problem, the applicant has proposed a plating apparatus wherein a high-resistance structure 208, which has lower electric resistivity than the electric resistivity of the plating solution, is disposed between an anode 202 and a substrate W, as shown in FIG. 3. With this structure, an electric equivalent circuit diagram is shown in FIG. 3., and a resistance Rp of the high-resistance structure 208 is added as compared to the electric equivalent circuit diagram shown in FIG. 2. Therefore, if a value of the resistance Rp of the high-resistance structure 208 becomes high, a value ((R2+R3+Rp+R4)/(R2+R3+Rp+R4+R5)) comes near one, the influence of the resistance R5, i.e., a resistant factor (sheet resistance) of the conductive layer becomes low.

### SUMMARY OF THE INVENTION

As a seed layer becomes thinner and the sheet resistance of a surface (surface to be plated) of a substrate becomes higher with the progress toward seed layer-less substrates, it becomes more and more difficult to form a plated film having a uniform thickness over an entire surface of a substrate having fine interconnect recesses formed in the surface while securely filling the interconnect recesses with the metal (interconnect material) without forming voids in the embedded metal.

For example, the use of a porous structure having an apparent porosity of 20% (in accordance with JIS R 2205) as the high-resistance structure 208 shown in FIG. 3 may provide a plated film having a sufficient in-plane uniformity of plated film thickness in the current 65 nm-node generation, as shown in FIG. 4. It is considered, however, that variation in the thickness of a plated film formed on a surface or a substrate becomes increasingly larger in the next 45 nm-node generation and the following 32 nm-node generation and the formation of a plated film having a sufficient in-plating uniformity of plated film thickness becomes increasingly difficult.

Further, it is generally difficult to produce such a plated film as not to impose a burden on a CMP processing while preventing deterioration of the quality of the plated film and scratches in a surface of the plated film. In this sense, the existing semiconductor manufacturing process is not perfect.

The present invention has been made in view of the above situation. It is therefore a first object of the present invention to provide a plating apparatus and a plating method which can form a plated film having a more uniform thickness over an entire surface of a substrate and can securely fill interconnect recesses with the metal without forming voids in the embedded metal even when the substrate has a high sheet resistance in the surface.

It is a second object of the present invention to provide a plating apparatus and a plating method which can form a plated film that facilitates a CMP processing, thus reducing the burden on the next-step CMP processing.

It is a third object of the present invention to provide an electrolytic processing apparatus and an electrolytic processing method which, when applied to e.g. an electroplating apparatus, can form a plated film having an enhanced in-plane uniformity of film thickness on a surface of a substrate even when the substrate is a large-area substrate with a thin conductive layer having a high electric resistance formed in the surface.

In order to achieve the above objects, the present invention provides a plating apparatus comprising: a substrate holder for holding a substrate; a cathode portion including a cathode for contact with the substrate held by the substrate holder to feed electricity to the substrate; and an anode, partly or wholly having a high resistance, disposed opposite a surface of the substrate held by the substrate holder; wherein plating of the surface of the substrate is carried out while filling between the anode and the substrate held by the substrate holder with a plating solution.

By carrying out plating using the anode partly or wholly having a high resistance, it becomes possible to allow the anode to have its own terminal effect. Further, by providing a feeding point to the anode at a certain one point in the center of the anode, it becomes possible to cause the anode to produce a terminal effect, in the reverse direction to the terminal effect of the surface of the substrate, which increases voltage drop with distance from the center of the anode. Further, by making the resistances (sheet resistances) of the anode and the surface of the substrate, facing each other, at the same level, the sum of the voltage drop in the surface of the substrate and the voltage drop in the anode can be made equal for a current pathway running through the center of the substrate surface, for a current pathway running through the peripheral region of the substrate, and for any intermediate current pathway between them. Thus, the electric resistance can be made equal for any current pathway, whereby electric current can be distributed evenly over the substrate surface and the thickness of a plated film formed on the substrate surface can be made uniform.

As a plated film grows on a surface of a substrate, the electric resistance (sheet resistance) of the surface of the substrate decreases and the terminal effect in the surface of the substrate becomes smaller gradually. When plating is continued, because of the terminal effect of the anode, the resulting plated film will be thick in the center of the substrate and thin in the peripheral region of the substrate. If a feeding point to the anode, partly or wholly having a high resistance, is provided not in the center but in the peripheral region of the anode, the direction of the terminal effect of the anode will be the same as the terminal effect of the surface of the substrate. Accordingly, when plating is continued using such an anode, the resulting plated film will be thin in the center of the substrate and thick in the peripheral region of the substrate.

Thus, in the case of carrying out plating with the use of an anode, partly or wholly having a high resistance, a change in the position of a feeding point to the anode produces a significant difference in the thick distribution of plated film. By providing feeding points to the anode both in the center and in the peripheral region of the anode so that plated films having reverse thickness distributions are combined, a plated film having a uniform thickness distribution over the entire substrate surface can be formed. Further, by providing each of the feeding points, to the center and to the peripheral portion of the anode, with a switch capable of on/off switching of a power source or an electric current and controlling the current ratio or the on/off time ratio, a plated film having a more uniform thickness distribution can be obtained. Furthermore, when an additional feeding point to the anode is provided between the central and the peripheral feeding points, a more precise control of the thickness distribution of plated film becomes possible.

In a preferred embodiment of the present invention, the high resistance of the anode is set at the same level as the resistance of the anode-facing surface of the substrate held by the substrate holder.

By making the high resistance (sheet resistance) of part or the whole of the anode at the same level as the resistance (sheet resistance) of the substrate surface (surface to be plated), the terminal effect produced in the anode can be made at the same level as the terminal effect produced in the substrate surface, thereby counterbalancing the influence of both terminal effects.

Preferably, the high resistance of part or the whole of the anode is higher than the electric resistance of the plating solution.

In a preferred aspect of the present invention, the high resistance of part or the whole of the anode is provided radially from the center of the anode.

This makes it possible to produce a terminal effect in the anode in the reverse direction to the terminal effect of the surface of the substrate by feeding electricity to the anode from its center. In this regard, a high resistance is necessary only in the radial direction from the center of an anode in order to increase voltage drop with distance from the center. Thus, the anode may have a low resistance in the height direction or in the circumferential direction. By utilizing this, it is possible to attach a ring-shaped contact to the anode so as to improve uniformity of the anode potential in the circumferential direction. The anode may be made to have a high resistance radially with distance from its center by decreasing the cross-sectional area radially from the center, i.e., by gradually decreasing the thickness of the anode with distance from the center.

The part or the whole of the anode having the high resistance is preferably composed of a material having a high resistivity.

The anode can be made to partly or wholly have a high resistance by using a material having a high resistivity. Examples of the material having a high resistivity include a conductive plastic, such as a conductive PEEK (polyether ether ketone) having a slight conductivity, a conductive ceramic and a conductive glass. It is possible to use a material having a high resistivity in combination with a material having a low resistivity.

Preferably, a thin metal film and/or a thin metal oxide film is provided on a substrate-facing surface of the anode which faces the surface of the substrate held by the substrate holder.

The provision of a thin metal film on a substrate-facing surface of the anode enables a plating current to flow evenly between the anode (thin metal film) and the surface of a substrate. Further, by covering the thin metal film with a thin metal oxide film, the thin metal film can be prevented from being oxidized or peeled off from the anode. The thin metal film can be exemplified by titanium, and the thin metal oxide film can be exemplified by iridium oxide.

In a preferred aspect of the present invention, a central contact, in contact with a feeding wire, for feeding electricity to the anode is provided in the center of the anode.

By feeding electricity to the anode, partly or wholly having a high resistance, from the center of the anode so as to allow an electric current to flow in the anode from the center toward the periphery, a terminal effect in the reverse direction to the terminal effect of the surface of the substrate can be produced in the anode.

In a preferred aspect of the present invention, a peripheral contact, in contact with a feeding wire, for feeding electricity to the anode is provided in the peripheral region of the anode continuously over the entire circumference.

By feeding electricity to the anode, partly or wholly having a high resistance, from the peripheral region of the anode so as to allow an electric current to flow in the anode from the peripheral region toward the center, a terminal effect in the same direction as the terminal effect of the surface of the substrate can be produced in the anode. Further, by providing a ring-shaped peripheral contact over the entire circumference of the anode, uniformity of the anode potential in the circumferential direction can be improved.

Preferably, at least one intermediate contact, in contact with a feeding wire, for feeding electricity to the anode is provided between the central contact and the peripheral contact of the anode continuously over the entire circumference.

By thus increasing the number of points for feeding electricity to the anode, an electric current flowing in the anode can be finely adjusted to form a plated film having a more uniform thickness on the surface of the substrate.

Preferably, the plating apparatus has plating power sources respectively for each of the feeding wires for feeding electricity to the anode.

This makes it possible to independently control an electric current flowing in the anode from the center toward the peripheral region of the anode, an electric current flowing in the anode from the peripheral region toward the center of the anode, etc., thereby forming a plated film having a more uniform thickness on the surface of the substrate.

Preferably, the plating apparatus has switches for on/off switching of electric current respectively for each of the feeding wires for feeding electricity to the anode.

This makes it possible to independently change the time for an electric current to flow in the anode from the center toward the peripheral region of the anode, the time for an electric current to flow in the anode from the peripheral region toward the center of the anode, etc., thereby forming a plated film having a more uniform thickness on the surface of the substrate. Further, the cost and the size of the apparatus can be reduced as compared to the case of providing an independent power source for each feeding wire.

The plated film to be formed on the surface of the substrate is, for example, copper.

The present invention provides a plating method comprising: preparing a substrate having interconnect recesses covered with a barrier layer or a seed layer in a surface; disposing an anode, partly or wholly having a high resistance, opposite the surface of the substrate; filling between the substrate and the anode with a plating solution; and carrying out plating by feeding electricity to the barrier layer or the seed layer from its peripheral region and feeding electricity to the anode from its center in the early stage of plating, and carrying out plating by feeding electricity to the barrier layer or the seed layer from its peripheral region and feeding electricity to the anode from its peripheral region in the later stage of plating.

The present invention provides another plating apparatus comprising: a substrate holder for holding a substrate; a cathode portion including a cathode for contact with the substrate held by the substrate holder to feed electricity to the substrate; an anode disposed opposite a surface of the substrate; and a contact member disposed between the substrate held by the substrate holder and the anode movably in a direction closer to or away from the substrate, said contact member having through-holes extending linearly through the contact member in said movement direction.

When carrying out plating of a substrate by providing a contact member, having through-holes linearly extending vertically to an anode and the substrate, between the anode and the substrate and bringing the contact member into contact with the surface of the substrate, a surface of the substrate in non-interconnect regions, except portions facing the through-holes provided in the contact member, directly contacts the contact member and the plating solution is excluded from the contact area. Accordingly, columnar plated films (columnar portions), which have grown along the through-holes, are formed. On the other hand, the interior surfaces of interconnect recesses, such as trenches, in interconnect regions are not in contact with the contact member, and the recesses are filled with the plating solution. Accordingly, in the interconnect regions a plated film first grows such that it fills in the recesses such as trenches and, after the plated film has grown to come into contact with the surface of the contact member, the plated film further grows in the form of columns along the through-holes of the contact member. Foots of the columnar plated films (columnar portions) formed in the non-interconnect regions and the interconnect regions lie on the same level.

When polishing the surface, having such columnar plated films, by CMP, the numerous columnar plated films on the surface can be easily removed with a relatively small force. After the removal of the numerous columnar plated films, the substrate surface takes on a flat surface with few irregularities, which is easier to polish with CMP as compared with a conventional plated film having surface irregularities.

Preferably, the plating apparatus further comprises a press mechanism for pressing a contact surface, which faces the surface of the substrate held by the substrate holder, of the contact member against the surface of the substrate.

Thus, the substrate-facing contact surface of the contact member can be kept pressed against the surface of the substrate, held by the substrate holder, by the press mechanism while the contact member is in contact with the substrate.

A press member for pressing the contact surface of the contact member against the surface of the substrate may be disposed between the contact member and the anode.

Thus, the contact surface of the contact member may be kept pressed against the surface of the substrate by the press member while the contact member is in contact with the substrate. The contact member may be composed of a material, such as a porous material, which can pass electricity therethrough, i.e., can pass a plating solution therethrough.

A flexible cushioning material for uniformly pressing the contact surface of the contact member against the surface of the substrate may be disposed between the contact member and the anode.

Thus, the entire contact surface of the contact member can be pressed against the surface of the substrate at a more uniform pressure by the cushioning member, thereby preventing the contact surface of the contact member from separating from the surface of the substrate locally.

The through-holes provided in the contact member may have a circular cross-sectional shape with a diameter of, for example, not more than 12 μm, and may be distributed at a density of 1.0×10⁵ to 1.0×10⁹/cm².

In this case, the columnar plated films formed on the surface of the substrate have a cylindrical shape having a diameter of not more than 12 μm and are distributed at a density of 1.0×10⁵ to 1.0×10⁹/cm². Such cylindrical plated films can be easily removed by later CMP. Further, this can prevent a case in which a through-hole is too large compared to an interconnect recess, such as a trench, to form a columnar (cylindrical) plated film in the interconnect region.

The contact surface of the contact member preferably has an Ra value, indicative of surface roughness, of not more than 1 μm.

By making the Ra value (center-line average roughness) of the contact surface of the contact member not more than 1 μm, the contact surface can be made to make tight contact with the surface of the substrate, thus preventing the formation of a gap between the contact surface and the substrate surface upon their contact. This can prevent an extra plated film being formed in a non-interconnect region and imposing a burden on a later CMP processing.

The contact member is preferably composed of an insulating material.

For example, the contact member is composed of polycarbonate, a ceramic, carbon, polyester, glass, silicon, a resist material or a fluorocarbon resin.

Resist materials for photolithography or X-ray lithography can be used as the resist material. For example, the use of PMMA (polymethyl methacrylate) or SU-8 (trade name, manufactured by Kayaku Microchem Corp.) enables fine patterning at a high aspect ratio and can provide a thick film (contact member) having fine through-holes.

A contact member composed of a fluorocarbon resin may be exemplified by a contact member of PFA having fine through-holes which have been formed by a lithography technique.

Preferably, the plating apparatus further comprises an etching mechanism for etching a plated film formed on the surface of the substrate.

The burden on a later CMP processing can be further reduced by etching away columnar plated films, which have been formed on the surface of the substrate, by the etching mechanism. Examples of the etching mechanism include etching by a power source capable of reversing polarity or an equivalent circuit, and etching with a chemical (chemical etching).

Preferably, each of the through-holes provided in the contact member is tapered such that the cross-sectional area gradually decreases with distance from the contact surface.

Pointed tapered columnar plated films will therefore be formed on the surface of the substrate. When providing such tapered through-holes, e.g., having a large diameter, in the contact member and forming tapered plated films in the through-holes, the plated films can be easily drawn out of the through-holes after plating.

The present invention provides another plating method comprising: preparing a substrate having interconnect recesses formed in a surface; disposing an anode opposite the surface of the substrate; disposing a contact member, having linearly-extending through-holes, between the substrate and the anode such that a contact surface, which faces the surface of the substrate, of the contact member is in pressure contact with the surface of the substrate; and carrying out plating of the surface of the substrate by passing a plating current between the anode and the surface of the substrate while filling between the anode and the substrate with a plating solution.

Preferably, the plating of the surface of the substrate is carried out while keeping the contact member stationary with respect to the substrate.

Preferably, after carrying out the plating of the surface of the substrate, the position of the contact surface of the contact member relative to the surface of the substrate is changed, and additional plating of the surface of the substrate is carried out.

When interconnect recesses, such as trenches, are deep and a lot of time is therefore necessary for plating, this manner of plating can prevent columnar plated films from growing so much that the films cannot be easily drawn out of the through-holes provided in the contact member.

The position of the contact surface of the contact member relative to the surface of the substrate may be changed after separating the contact member from the surface of the substrate.

When again pressing the contact member against the surface of a substrate after separating the contact member from the substrate surface, the contact member will push down columnar plated films which have been formed till then. New columnar plated films can then be grown on the fallen plated films by the next plating. By repeating this, a level difference in the surface irregularities of a plated film can be gradually decreased without damage to the contact member and columnar plated films, which have been formed on the substrate surface when embedding of the plated metal in interconnect recesses is completed, can be made relatively low. Such columnar plated films can be drawn out of the porous contact member without damage to the contact member. The relative position between the contact member and the substrate can, of course, be changed by actively moving the contact member or the substrate. In addition, the relative position can also be changed by a dimensional design error or allowance.

Preferably, before carrying out the additional plating of the surface of the substrate, a plated film formed on the surface of the substrate is subjected to etching.

In a preferred aspect of the present invention, the etching is carried out by reversing the polarities in plating of the anode and the surface of the substrate while filling between the anode and the substrate with the plating solution.

The etching is preferably carried out while keeping the contact member at a distance from the surface of the substrate.

When carrying out etching in this manner, the flow of electric current is concentrated in protruding columnar plated films, whereby the columnar plated films are etched preferentially than the plated film embedded in interconnect recesses. After the columnar plated films are removed by etching, the next plating is carried out. By repeating this procedure, a level difference in the surface irregularities of a plated film can be gradually decreased without damage to the contact member and columnar plated films, which have been formed on the substrate surface when embedding of the plating metal in the interconnect recesses is completed, can be made relative low. Such columnar plated films can be drawn out of the contact member without damage to the contact member. Further, by carrying out the etching under isotropic-etching conditions by applying the reverse electric field to that of plating between the anode and the surface of the substrate so as to etch away those parts of columnar plated films which correspond to half of the thickness, the columnar plated films can be removed by etching irrespective of their heights.

The present invention provides a substrate processing method comprising: carrying out plating of a substrate by the plating method according to claim 23; and then polishing a surface of the substrate by a CMP apparatus, thereby removing an extra plated film present outside interconnect portions.

The present invention provides another substrate processing method comprising: carrying out plating of a substrate by the plating method according to claim 23; subsequently removing columnar portions on a surface of the substrate by an etching apparatus to flatten the surface; and then polishing the substrate surface by a CMP apparatus, thereby removing an extra plated film present outside interconnect portions.

The present invention provides a plated film comprising numerous columnar portions, obtained by a plating process comprising plating a surface of a substrate while keeping a contact member, having linearly-extending through-holes, in contact with a surface of the substrate to grow the columnar portions linearly along the through-holes.

Preferably, the columnar portions are circular portions having a diameter of not more than 12 μm.

The present invention provides an electrolytic processing apparatus comprising: a substrate holder for holding a substrate; a first electrode for contact with a substrate to feed electricity to a surface of the substrate; a second electrode disposed opposite the surface of the substrate held by the substrate holder; a porous structure having a pressure loss of not less than 500 kPa, disposed between the substrate held by the substrate holder and the second electrode; an electrolytic solution injection section for injecting an electrolytic solution into between the substrate held by the substrate holder and the second electrode; and a power source for applying a voltage between the first electrode and the second electrode.

The electric resistance between a substrate (first electrode) and the second electrode can be made still larger by disposing a porous structure having a pressure loss of not less than 500 kPa between the substrate (first electrode) and the second electrode. This can further reduce the effect of the electric resistance of a conductive layer formed on a surface of the substrate and make the electric field more uniform over the entire surface of the substrate. Thus, when the electrolytic processing apparatus is employed as an electroplating apparatus, a practical plated film having a high in-plane uniformity of film thickness with a thickness variation of no more than about 2% can be formed on the surface of the substrate.

In a preferred aspect of the present invention, the porous structure has a pressure loss of not less than 1000 kPa.

This enables the formation on a surface of a substrate of a plated film having a higher in-plane uniformity of film thickness with a film thickness variation of no more than about 1.2%. The pressure loss of the porous structure is more preferably not less than 1500 kPa.

The present invention provides another electrolytic processing apparatus comprising: a substrate holder for holding a substrate; a first electrode for contact with a substrate to feed electricity to a surface of the substrate; a second electrode disposed opposite the surface of the substrate held by the substrate holder; a porous structure having an apparent porosity of not more than 19%, disposed between the substrate held by the substrate holder and the second electrode; an electrolytic solution injection section for injecting an electrolytic solution into between the substrate held by the substrate holder and the second electrode; and a power source for applying a voltage between the first electrode and the second electrode.

The electric resistance between a substrate (first electrode) and the second electrode can be made larger by disposing a porous structure having an apparent porosity of not more than 19% between the substrate (first electrode) and the second electrode. This can reduce the effect of the electric resistance of a conductive layer formed in a surface of the substrate and make the electric field more uniform over the entire surface of the substrate. Thus, when the electrolytic processing apparatus is employed as an electroplating apparatus, a plated film having a higher in-plane uniformity of film thickness can be formed on the surface of the substrate. In order to reduce variation in the thickness of plated film, the apparent porosity of the porous structure is preferably not more than 15%, more preferably not more than 10%.

The present invention provides yet another electrolytic processing apparatus comprising: a substrate holder for holding a substrate; a first electrode for contact with a substrate to feed electricity to a surface of the substrate; a second electrode disposed opposite the surface of the substrate held by the substrate holder; a porous structure, disposed between the substrate held by the substrate holder and the second electrode, having an overall electric resistance which is not less than 0.02 time the sheet resistance of a surface conductive layer of the substrate, said overall electric resistance being the electric resistance between the upper and lower surfaces of the porous structure with its interior filled with an electrolytic solution; an electrolytic solution injection section for injecting the electrolytic solution into between the substrate held by the substrate holder and the second electrode; and a power source for applying a voltage between the first electrode and the second electrode.

By thus making the overall electric resistance between upper and lower surfaces of a porous structure with its interior filled with an electrolytic solution sufficiently high with respect to the sheet resistance (electric resistance) of a conductive layer formed in a substrate surface, the electric field can be made more uniform over the entire surface of the substrate. Thus, when the electrolytic processing apparatus is employed as an electroplating apparatus, a plated film having a higher in-plane uniformity of film thickness can be formed on the surface of the substrate.

In a preferred aspect of the present invention, the porous structure has a resistivity of not less than 1.0×10⁵ Ω·cm.

When the electrolytic processing apparatus is employed as an electroplating apparatus, the use of the porous structure whose own resistivity is high makes it possible to carry out plating with voltage highly-reproducible and stable to plating current. The resistivity of the porous structure is preferably not less than 1.0×10⁶ Ω·cm.

The porous structure is composed of, for example, silicon carbide, silicon carbide with oxidation-treated surface, alumina or a plastic, or a combination thereof.

The electric processing may be electroplating of Cr, Mn, Fe, Co, Ni, Cu, Zn, Ga, Ru, Rh, Pd, Ag, Cd, In, Sn, Sb, Os, Ir, Pt, Au, Hg, Tl, Pb or Bi, or an alloy thereof, or electrolytic etching.

The present invention provides an electrolytic processing method comprising: filling between a surface of a substrate, in contact with a first electrode, and a second electrode disposed opposite the surface of the substrate with an electrolytic solution; disposing in the electrolytic solution a porous structure of which the apparent porosity is adjusted to not more than 19%, or the pressure loss is adjusted to not less than 500 kPa, or at least one of the specific gravity and the water absorption is adjusted; and applying a voltage between the first electrode and the second electrode.

According to this method, electrolytic processing of a surface of a substrate can be carried out with the electric field at the surface of the substrate adjusted to the desired state so that the substrate after electrolytic processing can have a processed surface in the intended state. The electric field can be made more uniform over an entire surface of a substrate by adjusting the apparent porosity of the porous structure to not more than 19%, preferably not more than 15%, more preferably not more than 10%, or adjusting the pressure loss to not less than 500 kPa, preferably not less than 1000 kPa, more preferably not less than 1500 kPa. Thus, in the case where the electrolytic processing is plating, the in-plane uniformity of a thickness of a plated film formed on a surface of a substrate can be enhanced.

The present invention provides another electrolytic processing method comprising: filling between a surface of a substrate, in contact with a first electrode, and a second electrode disposed opposite the surface of the substrate with an electrolytic solution; disposing in the electrolytic solution a porous structure of which the apparent porosity is adjusted to not more than 19%, or the overall electric resistance is adjusted to not less than 0.02 time the sheet resistance of a surface conductive layer of the substrate, said overall electric resistance being the electric resistance between the upper and lower surfaces of the porous structure with its interior filled with the electrolytic solution, or at least one of the specific gravity and the water absorption is adjusted; and applying a voltage between the first electrode and the second electrode.

The electric field can be made more uniform over an entire surface of a substrate also by adjusting the overall electric resistance between upper and lower surfaces of a porous structure with its interior filled with an electrolytic solution to not less than 0.02 time the sheet resistance of a surface conductive layer of the substrate. Thus, in the case where the electrolytic processing is plating, the in-plane uniformity of a thickness of a plated film formed on the surface of the substrate can be enhanced.

### BRIEF DESCRIPTION OF THE DRAWINGS

FIGS. 1A through 1C are diagrams illustrating, in a sequence of process steps, a process for forming copper interconnects by plating;

FIG. 2 is a diagram showing a conventional electroplating apparatus;

FIG. 3 is a diagram showing an electroplating apparatus having a high-resistance structure;

FIG. 4 is a graphical diagram showing thickness distributions of plated films which are expected to be obtained when plating is carried out on substrates of the current generation, the next generation and its next generation by using a porous structure having an apparent porosity of 20% as the high-resistance structure of the electroplating apparatus shown in FIG. 3;

FIG. 5 is an overall plan view of a substrate processing apparatus incorporating a plating apparatus according to an embodiment of the present invention;

FIG. 6 is a plan view of the plating apparatus shown in FIG. 5;

FIG. 7 is an enlarged cross-sectional view of a substrate holder and a cathode portion of the plating apparatus shown in FIG. 5;

FIG. 8 is a front view of a pre-coating/recovery arm of the plating apparatus shown in FIG. 5;

FIG. 9 is a plan view of the substrate holder of the plating apparatus shown in FIG. 5;

FIG. 10 is a cross-sectional view taken along line B-B of FIG. 9;

FIG. 11 is a cross-sectional view taken along line C-C of FIG. 9;

FIG. 12 is a plan view of the cathode portion of the plating apparatus shown in FIG. 5;

FIG. 13 is a cross-sectional view taken along line D-D of FIG. 12;

FIG. 14 is a plan view of an electrode arm section of the plating apparatus shown in FIG. 5;

FIG. 15 is a schematic cross-sectional diagram of the plating apparatus shown in FIG. 5, showing an electrode head and a substrate held by the substrate holder during plating;

FIG. 16 is a diagram illustrating an anode having a high resistance in the radial direction;

FIG. 17 is a diagram illustrating provision of a switch for each feeding contact to an anode;

FIG. 18 is a diagram illustrating provision of a central contact, a peripheral contact and an intermediate contact in a surface of an anode;

FIG. 19 is a perspective view showing another anode;

FIG. 20 is a schematic cross-sectional diagram of a plating apparatus according to another embodiment of the present invention, showing an electrode head and a substrate held by a substrate holder immediately before plating;

FIG. 21 is a schematic cross-sectional diagram of the plating apparatus of FIG. 20, showing the electrode head and the substrate held by the substrate holder during plating;

FIG. 22 is an enlarged view of the main portion of FIG. 21;

FIGS. 23A through 23D are diagrams illustrating a process of the formation of plated film in a non-interconnect region by a plating method according to an embodiment of the present invention;

FIGS. 24A through 24D are diagrams illustrating a process of the formation of plated film in an interconnect region by the plating method according to the embodiment of the present invention;

FIGS. 25A and 25B are diagrams illustrating a process of removing, by CMP processing, columnar plated films formed by the plating method according to the embodiment of the present invention;

FIGS. 26A through 26E are diagrams illustrating a process of the formation of plated film on a surface of a substrate by a plating method according to another embodiment of the present invention;

FIGS. 27A and 27B are diagrams illustrating a process of removing columnar plated films by etching in the course of plating;

FIGS. 28A and 28B are diagrams illustrating a process of removing columnar plated films by isotropic etching in the course of plating;

FIGS. 29A and 29B are cross-sectional diagrams showing the main portion of a plating apparatus according to yet another embodiment of the present invention;

FIG. 30 is a cross-sectional diagram showing the main portion of a plating apparatus according to yet another embodiment of the present invention;

FIG. 31 is a schematic diagram of a plated film, as viewed obliquely from above, obtained by carrying out plating of a surface of a substrate while keeping a contact member, having linearly-extending through-holes, in contact with the substrate surface;

FIG. 32 is a schematic front view of a plated film obtained by carrying out plating of a surface of a substrate while keeping a contact member, having linearly-extending through-holes, in contact with the substrate surface;

FIG. 33 is a schematic cross-sectional diagram of a plating apparatus (electrolytic processing apparatus) according to yet another embodiment of the present invention, showing an electrode head and a substrate held by a substrate holder during electroplating;

FIG. 34 is a diagram showing the positional relationship between the substrate, a sealing member and a plating solution injection section during plating in the plating apparatus shown in FIG. 33;

FIG. 35 is a graphical diagram showing the relationship between the pressure loss and the electric resistivity of a porous structure of silicon carbide, as obtained by using porous structures having various pressure losses in the range of 100-2800 kPa; and measuring the voltage between a cathode (first electrode) and an anode (second electrode) when a predetermined current is passed between them, and calculating the electric resistivity of the porous structure from the relationship between the measured voltage and the current;

FIG. 36 is a graphical diagram showing the relationship between the electric resistivity of a porous structure and variation (relative standard deviation) of plated film thickness in a substrate surface (in the radial direction), as obtained by a simulation calculation;

FIG. 37 is a graphical diagram showing the relationship between the pressure loss of a porous structure and variation of plated film thickness, obtained from the data of FIGS. 35 and 36;

FIG. 38 is a graphical diagram showing the relationship between the apparent porosity and the electric resistivity of a porous structure of alumina, as obtained by using porous structures having various apparent porosities in the range of 1-30%; and measuring the voltage between a cathode (first electrode) and an anode (second electrode) when a predetermined current is passed between them, and calculating the electric resistivity of the porous structure from the relationship between the measured voltage and the current;

FIG. 39 is a graphical diagram showing the relationship between the apparent porosity of a porous structure and variation of plated film thickness, obtained from the data of FIGS. 36 and 38;

FIG. 40 is a graphical diagram showing the relationship between current and voltage, as observed when carrying out copper plating of a substrate by using porous structures of silicon carbide having an apparent porosity of 15% and a resistivity of 1.0×10³ to 1.0×10⁶ Ω·cm, and passing electric current between a cathode (first electrode) and an anode (second electrode);

FIG. 41 is a graphical diagram showing the results of analysis of a plated film thickness in a substrate surface (in the radial direction), as analyzed by changing the ratio R: the overall electric resistance between upper and lower surfaces of a porous structure with its interior filled with a plating solution/the sheet resistance of a seed layer (conductive layer) of ruthenium formed on a silicon substrate, in the range of 0.002-1 (R₀<R₁<R₂<R₃);

FIG. 42 is a graphical diagram showing the relationship between the electric resistance ratio R and variation of plated film thickness, calculated from the analytical results shown in FIG. 41;

FIGS. 43A and 43B are diagrams showing variations of the electrode head;

FIG. 44 is a diagram showing the main portion of a plating apparatus (electrolytic processing apparatus) according to yet another embodiment of the present invention together with a plating solution (electrolytic solution) circulation system; and

FIG. 45 is a diagram showing the positional relationship between a substrate, a sealing member and a plating solution injection section during plating in the plating apparatus shown in FIG. 44.

### DETAILED DESCRIPTION OF THE PREFERRED EMBODIMENTS

Preferred embodiments of the present invention will now be described in detail with reference to the drawings. The following embodiments relate to the application of the present invention useful for forming interconnects of copper by embedding copper in fine interconnect recesses formed in a surface of the substrate.

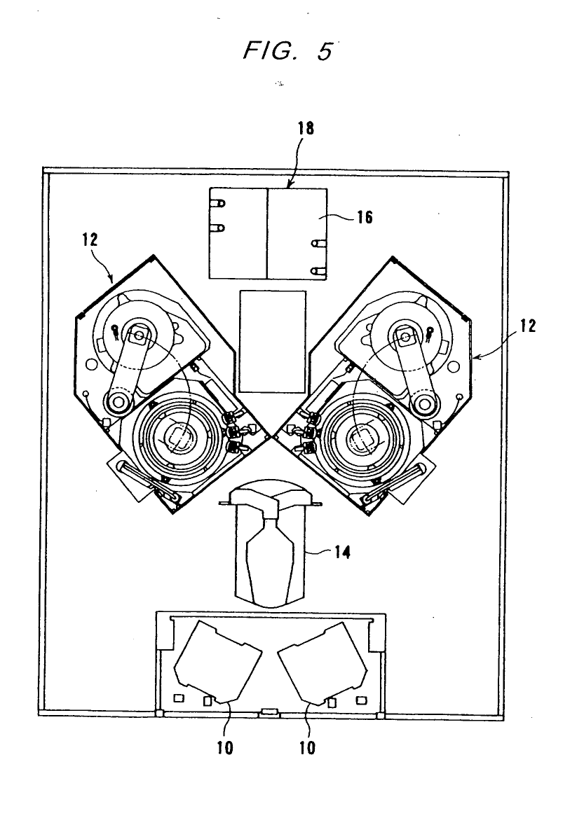

FIG. 5 is an overall layout showing a substrate processing apparatus incorporating a plating apparatus according to an embodiment of the present invention. As shown in FIG. 5, this substrate processing apparatus has a facility which houses therein two loading/unloading units 10 for housing a plurality of substrates W therein, two plating apparatuses 12 for performing plating process, a transfer robot 14 for transferring substrates W between the loading/unloading units 10 and the plating apparatuses 12, and plating solution supply equipment 18 having a plating solution tank 16.

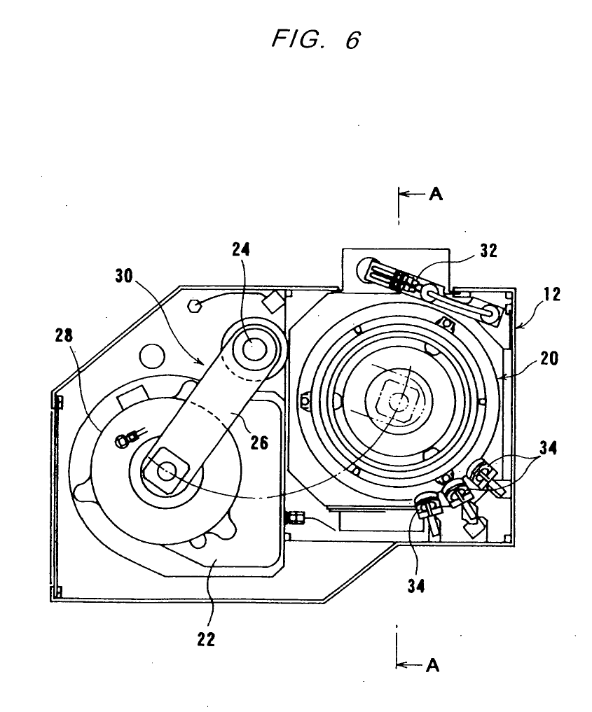

The plating apparatus 12, as shown in FIG. 6, is provided with a substrate processing section 20 for performing plating process and processing incidental thereto, and a plating solution tray 22 for storing a plating solution is disposed adjacent to the substrate processing section 20. There is also provided an electrode arm portion 30 having an electrode head 28 which is held at the front end of a pivot arm 26 pivotable about a rotating shaft 24 and which is swung between the substrate processing section 20 and the plating solution tray 22. Furthermore, a pre-coating/recovering arm 32, and fixed nozzles 34 for ejecting pure water or a chemical liquid such as ion water, and further a gas or the like toward a substrate are disposed laterally of the substrate processing section 20. In this embodiment, three of the fixed nozzles 34 are disposed, and one of them is used for supplying pure water.

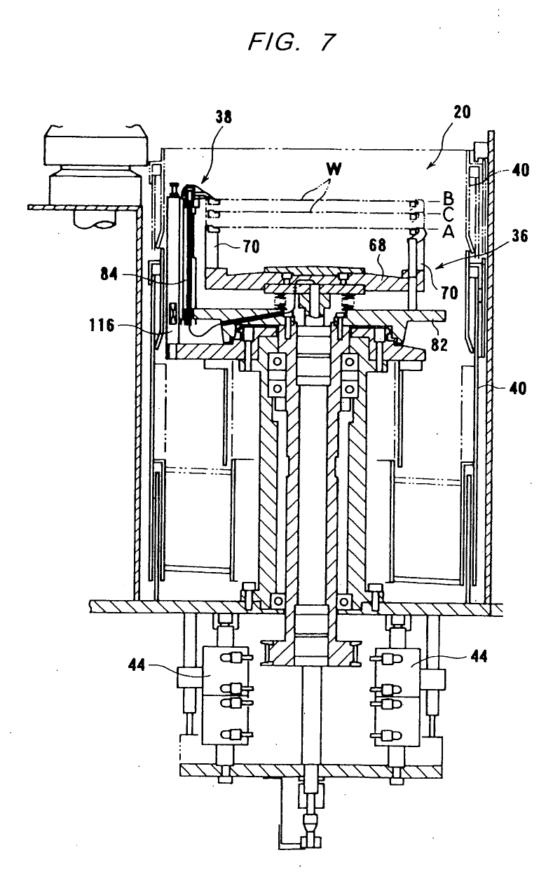

The substrate processing section 20, as shown in FIG. 7, has a substrate holder 36 for holding a substrate W with its surface (surface to be plated) facing upward, and a cathode portion 38 located above the substrate holder 36 so as to surround a peripheral portion of the substrate holder 36. Further, a substantially cylindrical bottomed cup 40 surrounding the periphery of the substrate holder 36 for preventing scatter of various chemical liquids used during processing is provided so as to be vertically movable by an air cylinder (not shown).

The substrate holder 36 is adapted to be raised and lowered by the air cylinder 44 between a lower substrate transfer position A, an upper plating position B, and a pretreatment/cleaning position C intermediate between these positions. The substrate holder 36 is also adapted to rotate at an arbitrary acceleration and an arbitrary velocity integrally with the cathode portion 38 by a rotating motor and a belt (not shown). Substrate carry-in and carry-out openings (not shown) are provided in confrontation with the substrate transfer position A in a side panel of the plating apparatus 12 facing the transfer robot 14. When the substrate holder 36 is raised to the plating position B, a sealing member 90 and cathodes 88 (to be described below) of the cathode portion 38 are brought into contact with the peripheral edge portion of the substrate W held by the substrate holder 36. On the other hand, the cup 40 has an upper end located below the substrate carry-in and carry-out openings, and when the cup 40 ascends, the upper end of the cup 40 reaches a position above the cathode portion 38 closing the substrate carry-in and carry-out openings, as shown by imaginary lines in FIG. 7.

The plating solution tray 22 serves to wet a porous structure 110 and an anode 98 (to be described later on) of the electrode arm portion 30 with a plating solution, when plating has not been performed. The plating solution tray 22 is set at a size in which the porous structure 110 can be accommodated, and the plating solution tray 22 has a plating solution supply port and a plating solution drainage port (not shown). A photo-sensor is attached to the plating solution tray 22, and can detect brimming with the plating solution in the plating solution tray 22, i.e., overflow, and drainage.

The electrode arm portion 30 is vertically movable by a vertical movement motor, which is a servomotor, and a ball screw (not shown), and swingable between the plating solution tray 22 and the substrate processing section 20 by a swing motor (not shown). An air actuator may be used instead of a motor.

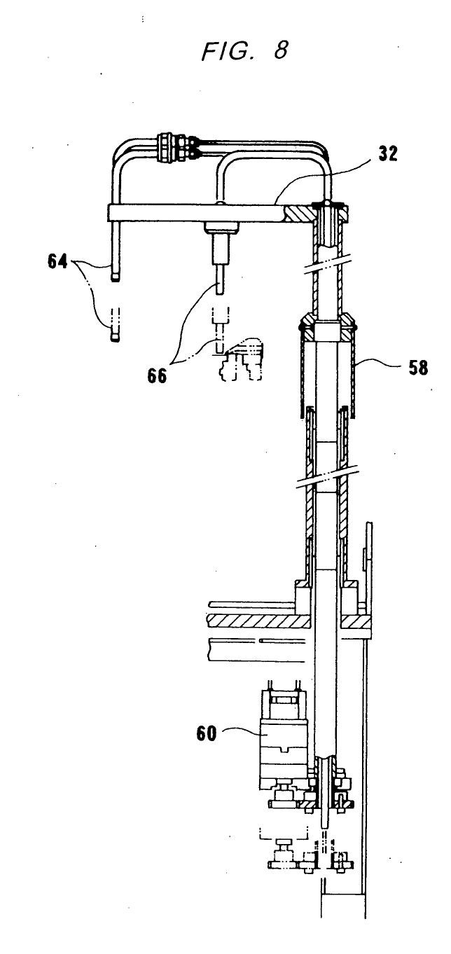

As shown in FIG. 8, the pre-coating/recovering arm 32 is coupled to an upper end of a vertical support shaft 58. The pre-coating/recovering arm 32 is swingable by a rotary actuator 60 and is also vertically moveable by an air cylinder (not shown) The pre-coating/recovering arm 32 supports a pre-coating nozzle 64 for discharging a pre-coating liquid, on its free end side, and a plating solution recovering nozzle 66 for recovering the plating solution, on a portion closer to its proximal end. The plating solution recovering nozzle 66 is connected to a cylinder pump or an aspirator, for example, to draw the plating solution on the substrate from the plating solution recovering nozzle 66.

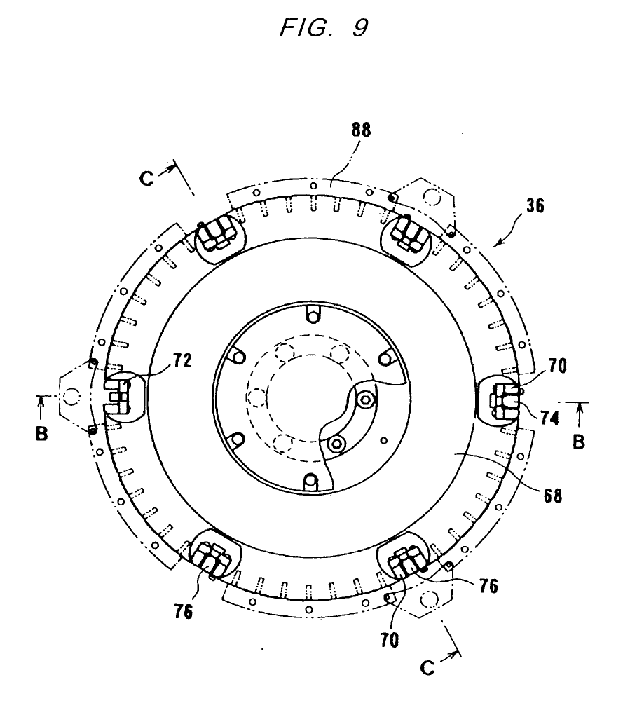

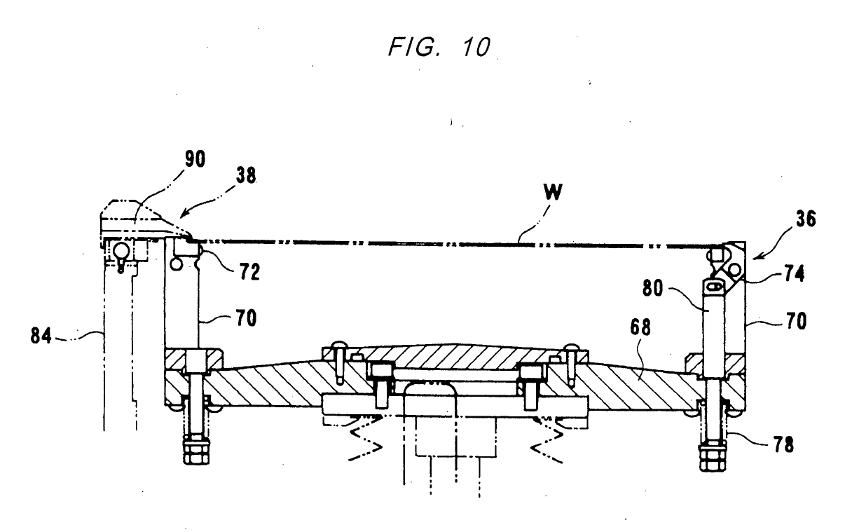

As shown in FIGS. 9 through 11, the substrate holder 36 has a disk-shaped substrate stage 68, and six vertical support arms 70 are disposed at spaced intervals on the circumferential edge of the substrate stage 68 for holding a substrate W in a horizontal plane on respective upper surfaces of the support arms 70. A positioning plate 72 is mounted on an upper end one of the support arms 70 for positioning the substrate by contacting the end face of the substrate. A pressing finger 74 is rotatably mounted on an upper end of the support arm 70, which is positioned opposite to the support arm 70 having the positioning plate 72, for abutting against an end face of the substrate W and pressing the substrate W to the positioning plate 72 when rotated. Chucking fingers 76 are rotatably mounted on upper ends of the remaining four support arms 70 for pressing the substrate W downwardly when rotated.

The pressing finger 74 and the chucking fingers 76 have respective lower ends coupled to upper ends of pressing pins 80 that are normally urged to move downwardly by coil springs 78. When the pressing pins 80 are moved downwardly, the pressing finger 74 and the chucking fingers 76 are rotated radially inwardly into a closed position. A support plate 82 is disposed below the substrate stage 68 for engaging lower ends of the opening pins 80 and pushing them upwardly.

When the substrate holder 36 is located in the substrate transfer position A shown in FIG. 7, the pressing pins 80 are engaged and pushed upwardly by the support plate 82, so that the pressing finger 74 and the chucking fingers 76 rotate outwardly and open. When the substrate stage 68 is elevated, the opening pins 80 are lowered under the resiliency of the coil springs 78, so that the pressing finger 74 and the chucking fingers 76 rotate inwardly and close.

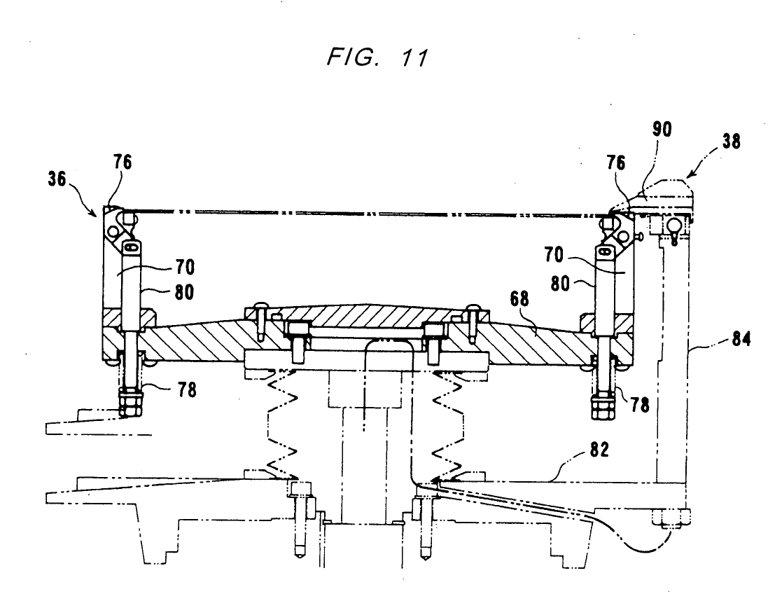

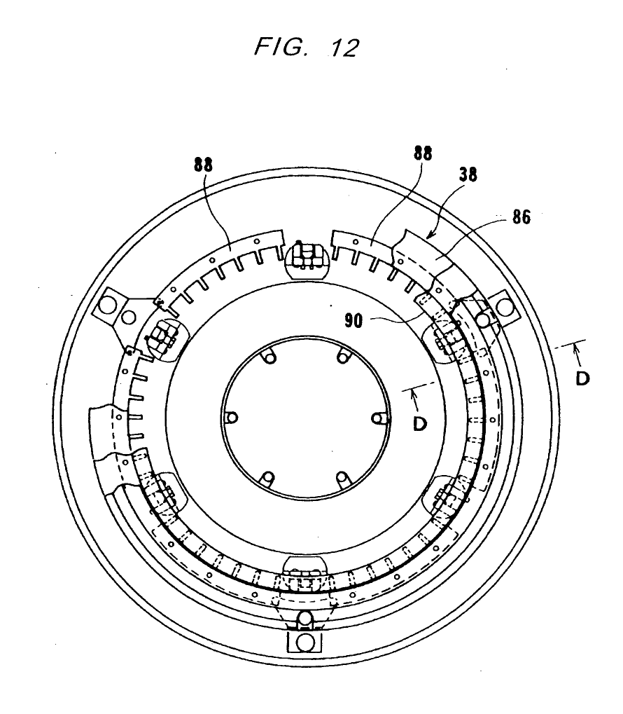

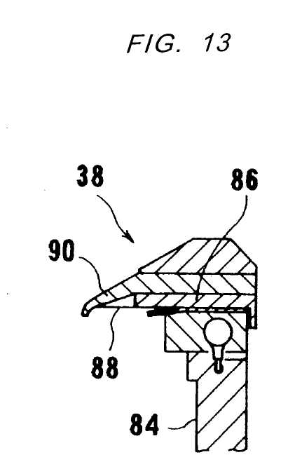

As shown in FIGS. 12 and 13, the cathode portion 38 comprises an annular frame 86 fixed to upper ends of vertical support columns 84 mounted on the peripheral edge of the support plate 82 (see FIG. 11), a plurality of, six in this embodiment, cathodes 88 attached to a lower surface of the annular frame 86 and projecting inwardly, and an annular sealing member 90 mounted on an upper surface of the annular frame 86 in covering relation to upper surfaces of the cathodes 88. The sealing member 90 is adapted to have an inner peripheral edge portion inclined inwardly downwardly and progressively thin-walled, and to have an inner peripheral end suspending downwardly.

When the substrate holder 36 has ascended to the plating position B, as shown FIG. 7, the cathodes 88 are pressed against the peripheral edge portion of the substrate W held by the substrate holder 36 for thereby allowing electric current to pass through the substrate w. At the same time, an inner peripheral end portion of the sealing member 90 is brought into contact with an upper surface of the peripheral edge of the substrate W under pressure to seal its contact portion in a watertight manner. As a result, the plating solution supplied onto the upper surface (surface to be plated) of the substrate W is prevented from seeping from the end portion of the substrate W, and the plating solution is prevented from contaminating the cathodes 88.

In this embodiment, the cathode portion 38 is vertically immovable, but rotatable in a body with the substrate holder 36. However, the cathode portion 38 may be arranged such that it is vertically movable and the sealing member 90 is pressed against the surface, to be plated, of the substrate W when the cathode portion 38 is lowered.

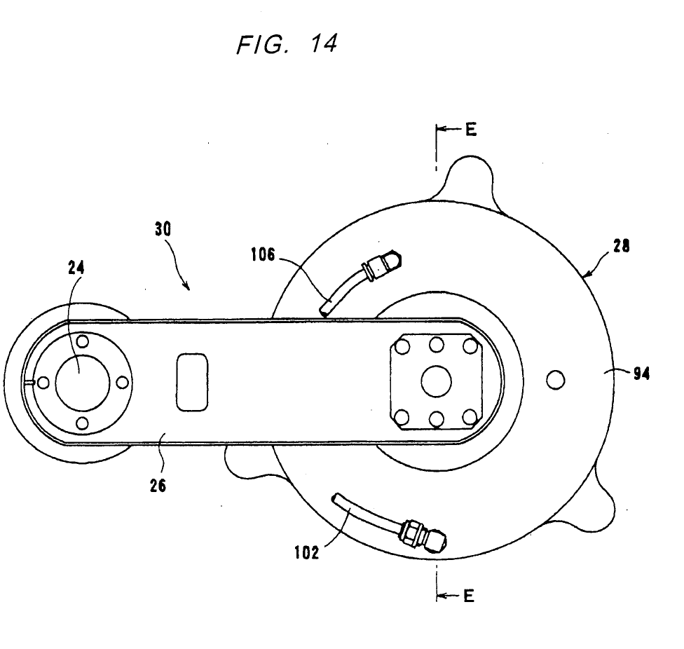

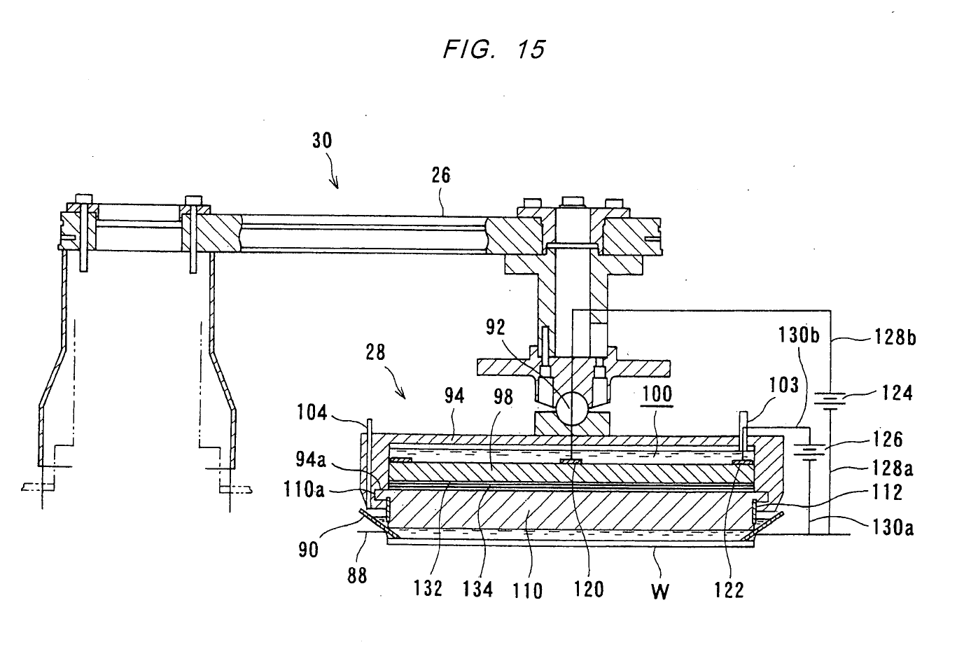

As shown in FIGS. 14 and 15, the electrode head 28 of the electrode arm section 30 includes a anode holder 94 which is coupled via a ball bearing 92 to the free end of the pivot arm 26, and a porous structure 110 which is disposed such that it closes the bottom opening of the anode holder 94. In particular, the anode holder 94 has the shape of a downwardly-open bottomed cup and has a recessed portion 94a at a lower position in the inner peripheral surface. The porous structure 110 has at its top a flange portion 110a that fits in the recessed portion 94a. The porous structure 110 is held in the anode holder 94 by fitting the flange portion 110a into the recessed portion 94a. A hollow plating solution chamber 100 is thus formed in the anode holder 94.

In this embodiment, the porous structure 110 is composed of porous ceramics such as alumina, SiC, mullite, zirconia, titania or cordierite, or a hard porous material such as a sintered compact of polypropylene or polyethylene, or a composite material comprising these materials, or a woven or non-woven fabric. For example, the porous structure 110 may be used having a pore diameter of 30 to 200 μm in the case of an alumina ceramic, or not more than 30 μm in the case of SiC, a porosity of 20 to 95%, and a thickness of 1 to 20 mm, preferably 5 to 20 mm, more preferably 8 to 15 mm. The porous structure 110, in this embodiment, is constituted of porous ceramics of alumina having a porosity of 30%, and an average pore diameter of 100 μm. The porous ceramic plate per se is an insulator, but it is constituted to have lower electric conductivity than the electric conductivity of the plating solution by causing the plating solution to enter its interior complicatedly and follow a considerably long path in the thickness direction.

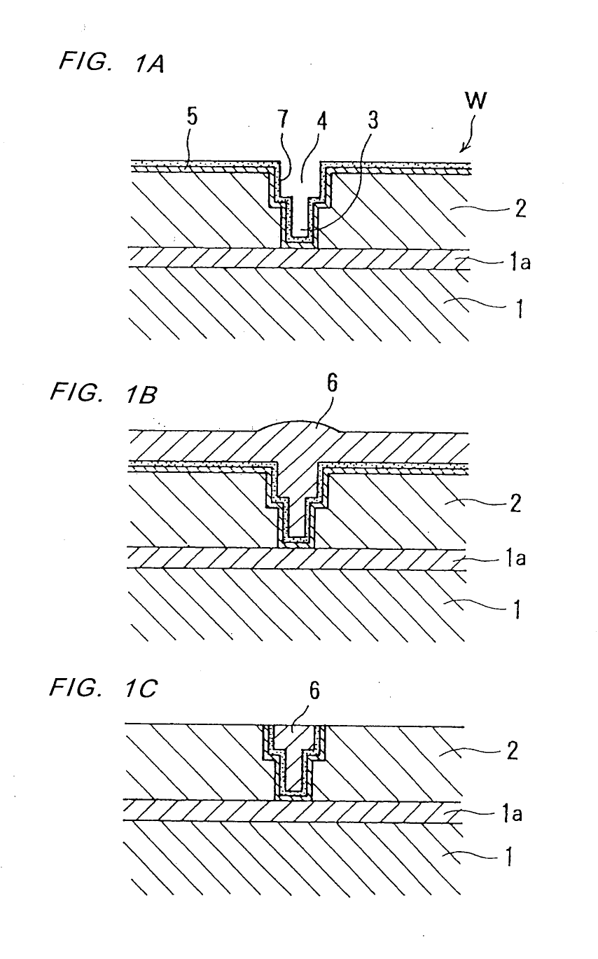

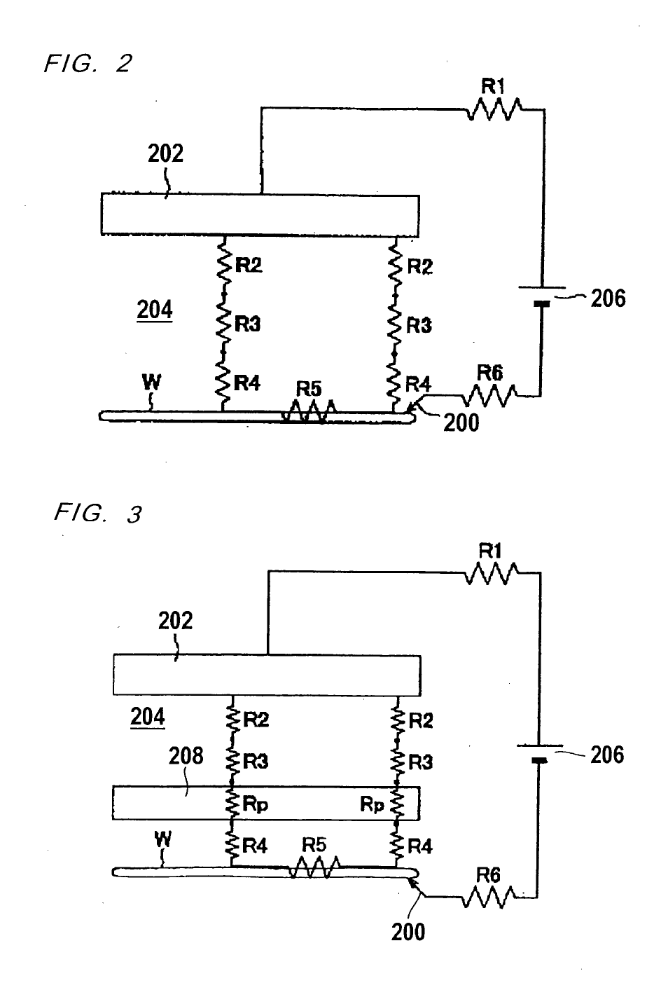

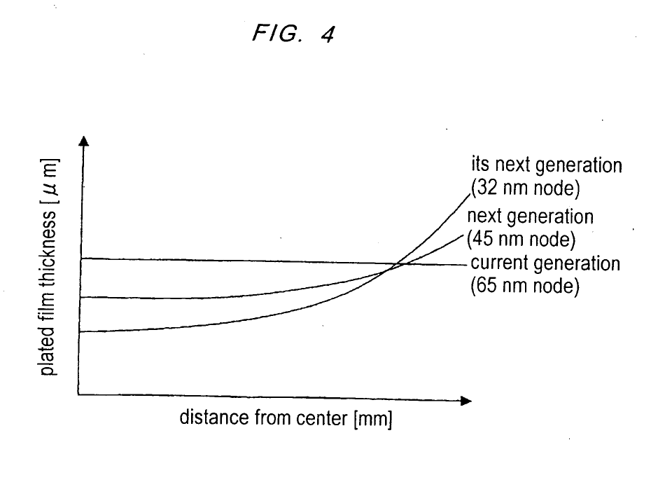

The porous structure 110, which has the high resistance, is disposed in the plating solution chamber 100. Hence, the influence of the resistance of the seed layer 7 (see FIG. 1A) becomes a negligible degree. Consequently, the difference in current density over the surface of the substrate due to electrical resistance on the surface of the substrate W becomes small, and the uniformity of the plated film over the surface of the substrate improves. In this embodiment, the porous structure 110 is provided so that the plating solution itself has high resistance, but the porous structure 110 may be omitted.

A disk-shaped mesh-like anode 98, which allows a plating solution to pass therethrough, is disposed in the plating solution chamber 100 above the porous structure 110. An anode, which has a number of vertical through holes defined therein, may be used as the anode 98. The anode holder 94 has a plating solution discharge port 103 for discharging, under suction, the plating solution from the plating solution chamber 100. The plating solution discharge port 103 is connected to a plating solution discharge pipe 106 extending from the plating solution supply equipment 18 (see FIG. 5). A plating solution injection section 104 is provided in a peripheral wall of the anode holder 94 at a position laterally of the anode 98 and the porous structure 110. In this embodiment, the plating solution injection section 104 comprises a tube having a lower end shaped as a nozzle, and is connected to a plating solution supply pipe 102 extending from the plating solution supply equipment 18 (see FIG. 5). The plating solution injection section 104 and the plating solution discharge comprises a plating solution exchanging section.

When the substrate holder 36 is in plating position B (see FIG. 7), the electrode head 28 is lowered until the gap between the substrate W held by the substrate holder 36 and the porous structure 110 becomes about 0.5 to 3 mm, for example, and then the plating solution injection section 104 pours the plating solution into a region between the substrate W and the porous structure 110 from laterally of the anode 98 and the porous structure 110. The nozzle at the lower end of the plating solution injection section 104 is open toward a region between the sealing member 90 and the porous structure 110. A shield ring 112 of rubber is mounted on the outer circumferential surface of the porous structure 110 for electrically shielding the porous structure 110.

When the plating solution is introduced, the plating solution introduced from the plating solution injection section 104 flows in one direction along the surface of the substrate W. The flow of the plating solution pushes and discharges the air out of the region between the substrate W and the porous structure 110, filling the region with the fresh plating solution whose composition has been adjusted that is introduced from the plating solution injection section 104. The plating solution is now retained in the region defined between the substrate W and the sealing member 90.

When copper plating is performed, copper (phosphorus-containing copper) containing 0.03 to 0.05% of phosphorus is generally used as an anode for suppressing the generation of slime. An insoluble electrode composed of an insoluble metal such as platinum or titanium, or an insoluble electrode comprising metal, on which platinum or the like is plated, is widely used as an anode. Such an anode is a resistance element having a resistance of almost zero, therefore a current flow is not impeded by the anode.

In this embodiment, the anode 98 has the shape of a mesh, such as a triangular lattice, which allows the plating solution to pass smoothly therethrough, and is composed of a material having a high resistivity, for example, a material comprising as the base material a ceramic having a slight electric conductivity, so that its resistance is at least higher than the resistance of the plating solution. The resistance (sheet resistance) of the substrate W-facing surface of the anode 98 is preferably at the same level as the resistance (sheet resistance) of the anode 98-facing surface of the substrate W held by the substrate holder 36. For example, when the sheet resistance of e.g., a surface seed layer of the substrate W is 40 Ω/□, the sheet resistance of the substrate W-facing surface of the anode 98 is preferably not less than 20 Ω/□. The anode 98 may be composed of a conductive plastic, such as a conductive PEEK having a slight conductivity, a conductive glass, or the like.

By making the sheet resistance of the substrate W-facing surface of the high-resistance anode 98 at the same level as the sheet resistance of the surface (surface to be plated) of the substrate W, the terminal effect produced in the anode can be made at the same level as the terminal effect produced in the substrate surface, thereby counterbalancing the both terminal effects.

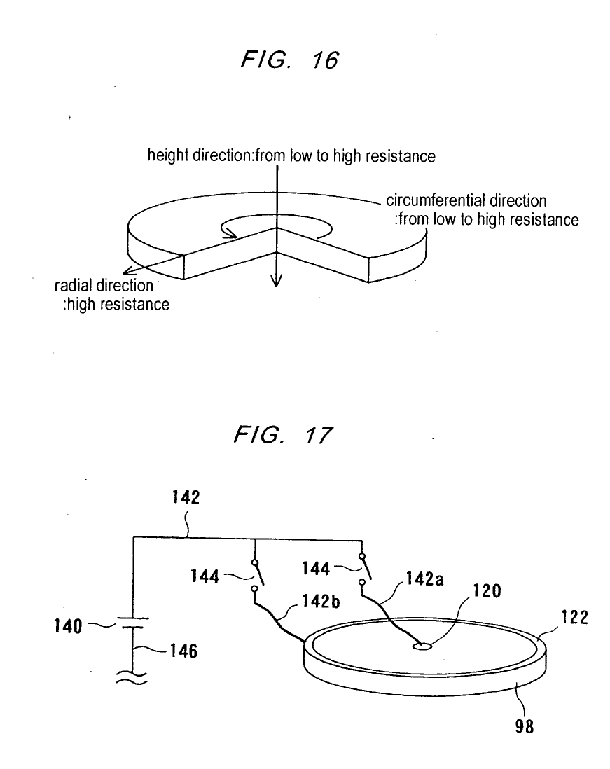

Further, by providing the anode 98 with a high resistance in the radial direction from the center of the anode 98 so as to produce a potential gradient in the anode 98 itself, it becomes possible to produce a terminal effect in the anode 98 in the reverse direction to the terminal effect of the surface of the substrate W when feeding electricity to the anode 98 from its center. In this regard, a high resistance is necessary only in the radial direction from the center of the anode 98, as shown in FIG. 16, in order to increase voltage drop with distance from the center of the anode 98. Thus, the anode 98 may have a low to high resistance in the height direction or in the circumferential direction. By utilizing this, it is possible to attach a ring-shaped contact to the anode so as to improve uniformity of the anode potential in the circumferential direction.

Though not depicted, the anode may be made to have a high resistance in the radial direction from its center by decreasing the cross-sectional area radially from the center, i.e., by gradually decreasing the thickness of the anode with distance from the center.

A central contact 120 is provided in the center of the substrate W-counterfacing surface (upper surface) of the anode 98, and a ring-shaped peripheral contact 122 continuously extending over the entire circumference is provided in the peripheral region of the upper surface of the anode 98. In this embodiment, two power sources are provided: a power source 124 for feeding electricity to the central contact 120 and to the cathode 88; and a power source 126 for feeding electricity to the peripheral contact 122 and to the cathode 88. A feeding wire 128a on the cathode side of the power source 124 is connected to the cathode 88, and a feeding wire 128b on the anode side is connected to the central contact 120; and a feeding wire 130a on the cathode side of the power source 126 is connected to the cathode 88, and a feeding wire 130b on the anode side is connected to the peripheral contact 122.

By feeding electricity from the power source 124 to the anode 98 from the center of the anode 98 so that an electric current flows in the anode 98 from the center toward the periphery of the anode 98, it becomes possible to cause the anode 98 to produce a terminal effect in the reverse direction to the terminal effect of the surface of the substrate W, i.e., a terminal effect which increases voltage drop radially with distance from the center of the anode 98. Further, by feeding electricity from the power source 126 to the anode 98 from the peripheral region of the anode 98 so that an electric current flows in the anode 98 from the peripheral region toward the center of anode 98, it becomes possible to cause the anode 98 to produce a terminal effect in the same direction of the terminal effect of the surface of the substrate W, i.e., a terminal effect which increases voltage drop radially with distance from the peripheral region of the anode 98.

The provision of the two power sources 124, 126 makes it possible to independently control an electric current flowing in the anode 98 from the center toward the peripheral region of the anode 98, and an electric current flowing in the anode 98 from the peripheral region toward the center of the anode 98, thereby forming a plated film having a more uniform thickness on the surface of the substrate W.

The substrate W-facing surface (lower surface) of the anode 98 is coated with a thin metal film 132 of e.g. titanium, and the surface of the thin metal film 132 is coated with a thin metal oxide film 134 of e.g. iridium oxide. The provision of the thin metal film 132 in the substrate W-facing surface of the anode 98 enables a plating current to flow evenly between the anode (thin metal film) 98 and the surface of the substrate W. Further, by covering the thin metal film 132 with the thin metal oxide film 134, the thin metal film 132 can be prevented from being oxidized or peeled off from the anode 98.

Next, the operation of the substrate processing apparatus incorporating the plating apparatus 12 of this embodiment will now be described.

First, a substrate W to be plated is taken out from one of the loading/unloading units 10 by the transfer robot 14, and transferred, with the surface (surface to be plated) facing upwardly, through the substrate carry-in and carry-out opening defined in the side panel, into one of the plating apparatuses 12. At this time, the substrate holder 36 is in lower substrate transfer position A. After the hand of the transfer robot 14 has reached a position directly above the substrate stage 68, the hand of the transfer robot 14 is lowered to place the substrate W on the support arms 70. The hand of the transfer robot 14 is then retracted through the substrate carry-in and carry-out opening.

After the hand of the transfer robot 14 is retracted, the cup 40 is elevated. Then, the substrate holder 36 is lifted from substrate transfer position A to pretreatment/cleaning position C. As the substrate holder 36 ascends, the substrate W placed on the support arms 70 is positioned by the positioning plate 72 and the pressing finger 74 and then reliably gripped by the fixing fingers 76.

On the other hand, the electrode head 28 of the electrode arm portion 30 is in a normal position over the plating solution tray 22 now, and the porous structure 110 or the anode 98 is positioned in the plating solution tray 22. At the same time that the cup 4o ascends, the plating solution starts being supplied to the plating solution tray 22 and the electrode head 28. Until the step of plating the substrate W is initiated, the new plating solution is supplied, and the plating solution discharge pipe 106 is evacuated to replace the plating solution in the porous structure 110 and remove air bubbles from the plating solution in the porous structure 110. When the ascending movement of the cup 40 is completed, the substrate carry-in and carry-out openings in the side panel is closed by the cup 40, isolating the atmosphere in the side panel and the atmosphere outside of the side panel from each other.

When the cup 40 is elevated, the pre-coating step is initiated. Specifically, the substrate holder 36 that has received the substrate W is rotated, and the pre-coating/recovering arm 32 is moved from the retracted position to a position confronting the substrate W. When the rotational speed of the substrate holder 36 reaches a preset value, the pre-coating nozzle 64 mounted on the tip end of the pre-coating/recovering arm 32 intermittently discharges a pre-coating liquid which comprises a surface active agent, for example, toward the surface (surface to be plated) of the substrate W. At this time, since the substrate holder 36 is rotating, the pre-coating liquid spreads all over the surface of the substrate W. Then, the pre-coating/recovering arm 32 is returned to the retracted position, and the rotational speed of the substrate holder 36 is increased to spin the pre-coating liquid off and dry the surface to be plated of the substrate W.

After the completion of the pre-coating step, the plating step is initiated. First, the substrate holder 36 is stopped against rotation, or the rotational speed thereof is reduced to a preset rotational speed for plating. In this state, the substrate holder 36 is lifted to plating position B. Then, the peripheral edge of the substrate W is brought into contact with the cathodes 88, when it is possible to pass an electric current, and at the same time, the sealing member 90 is pressed against the upper surface of the peripheral edge of the substrate W, thus sealing the peripheral edge of the substrate W in a watertight manner.

Based on a signal indicating that the pre-coating step for the loaded substrate W is completed, on the other hand, the electrode arm portion 30 is swung in a horizontal direction to displace the electrode head 28 from a position over the plating solution tray 22 to a position over the plating position. After the electrode head 28 reaches this position, the electrode head 28 is lowered toward the cathode portion 38. The electrode head 28 is stopped when the porous structure 110 has reached a position close to and not being into contact with the surface of the substrate W, the position being at a distance of about 0.5 mm to 3 mm from the surface of the substrate W. When the descent of the electrode head 28 is completed, a plating solution is poured into the region between the substrate W and the porous structure 110 from the plating solution injection section 104 to fill the region with the plating liquid.

In the early stage of plating, electricity is fed from the power source 124 to the anode 98 from the center of the anode 98 while electricity is fed through the cathode 88 to the surface, for example the seed layer 7 (see FIG. 1A), of the substrate W from the peripheral region of the substrate W, thereby forming a plated film on the surface of the substrate W. During plating, an electric current flows in the anode 98 from its center toward the periphery, producing a terminal effect in the anode 98 in the reverse direction to the terminal effect of the surface of the substrate W, i.e., a terminal effect which increases voltage drop radially with distance from the center of the anode 98. Accordingly, by making the resistances (sheet resistances) of the anode 98 and the surface of the substrate W, facing each other, at the same level, the sum of the voltage drop in the surface of the substrate W and the voltage drop in the anode 98 can be made equal for a current pathway running through the center of the surface of the substrate W, for a current pathway running through the peripheral region of the substrate W, and for any intermediate current pathway between them. Thus, the electric resistance can be made equal for any current pathway, whereby electric current can be distributed evenly over the surface of the substrate W and a plated film having a uniform thickness can be formed on the surface of the substrate w. During plating, the substrate holder 36 is rotated at a low speed, according to necessity.

As a plated film grows on the surface of the substrate W, the electric resistance (sheet resistance) of the surface of the substrate W decreases and the terminal effect in the surface of the substrate becomes smaller gradually. If plating is continued, because of the terminal effect of the anode 98, the resulting film will be thick in the center of the substrate W and thin in the peripheral region of the substrate W.

Therefore, when a thickness of the plated film has reached a predetermined thickness, the power source 124 is disconnected, and electricity is fed from the power source 126 to the anode 98 from the peripheral region of the anode 98 while electricity is fed through the cathode 88 to the surface of the substrate W from the peripheral region of the substrate W, thereby further forming a plated film on the above-described plated film which has been formed on the surface of the substrate W. During plating, an electric current flows in the anode 98 from the peripheral region to the center of the anode 98, producing a terminal effect in the anode 98 in the same direction as the terminal effect of the surface of the substrate W, i.e., a terminal effect which increases voltage drop radially with distance from the peripheral region of the anode 98. Accordingly, the plated film formed by this plating is thin in the center of the substrate W and thick in the peripheral region of the substrate W.

By thus combining plated films having reverse thickness distributions, the resulting film can have a uniform thickness distribution. This makes it possible to form a plated film having a more uniform thickness over an entire surface of a substrate and can securely fill fine interconnect recesses, such as contact holes 3 and trenches 4 (see FIG. 1A), with the metal without forming voids in the embedded metal.

When the plating process is completed, the electrode arm portion 30 is raised and then swung to return to the position above the plating solution tray 22 and to lower to the ordinary position. Then, the pre-coating/recovering arm 32 is moved from the retreat position to the position confronting to the substrate W, and lowered to recover the remainder of the plating solution on the substrate W by the plating solution recovering nozzle 66. After recovering of the remainder of the plating solution is completed, the pre-coating/recovering arm 32 is returned to the retreat position, and pure water is supplied from the fixed nozzle 34 for supplying pure water toward the central portion of the substrate W for rinsing the plated surface of the substrate. At the same time, the substrate holder 36 is rotated at an increased speed to replace the plating solution on the surface of the substrate W with pure water. Rinsing the substrate W in this manner prevents the splashing plating solution from contaminating the cathodes 88 of the cathode portion 38 during descent of the substrate holder 36 from the plating position B.

After completion of the rinsing, the washing with water step is initiated. That is, the substrate holder 36 is lowered from the plating position B to the pretreatment/cleaning position C. Then, while pure water is supplied from the fixed nozzle 34 for supplying pure water, the substrate holder 36 and the cathode portion 38 are rotated to perform washing with water. At this time, the sealing member 90 and the cathodes 88 can also be cleaned, simultaneously with the substrate, by pure water directly supplied to the cathode potion 38, or pure water scattered from the surface of the substrate W.

After washing with water is completed, the drying step is initiated. That is, supply of pure water from the fixed nozzle 34 is stopped, and the rotational speed of the substrate holder 36 and the cathode portion 38 is further increased to remove pure water on the substrate surface by centrifugal force and to dry the substrate surface. The sealing member 90 and the cathodes 88 are also dried at the same time. Upon completion of the drying, the rotation of the substrate holder 36 and the cathode portion 38 is stopped, and the substrate holder 36 is lowered to the substrate transfer position A. Thus, the gripping of the substrate W by the chucking fingers 76 is released, and the substrate W is just placed on the upper surfaces of the support arms 70. At the same time, the cup 40 is also lowered.

All the steps including the plating step, the pretreatment step accompanying to the plating step, the cleaning step, and the drying step are now finished. The transfer robot 14 inserts its hand through the substrate carry-in and carry-out opening into the position beneath the substrate W, and raises the hand to receive the plated substrate W from the substrate holder 36. Then, the transfer robot 14 returns the plated substrate W received from the substrate holder 36 to one of the loading/unloading units 10.

Though the two power sources 124, 126 are provided in this embodiment, as shown in FIG. 14, it is also possible to provide one power source 140, branch a feeding wire 142 extending from the anode of the power source 140 into two feeding wires 142a, 142b, connect one feeding wire 142a to the central contact 120 and connect the other feeding wire 142b to the peripheral contact 122, and interpose an on/off switch 144 in each of the feeding wires 142a, 142b. As with the above-described case, a feeding wire 146 extending from the cathode of the power source 140 is connected to the cathodes 88.

This makes it possible to independently change the time for an electric current to flow in the anode 98 from the center toward the peripheral region of the anode 98 and the time for an electric current to flow in the anode 98 from the peripheral region toward the center of the anode 98, or the ratio between these times by the switches 144, thereby forming a plated film having a more uniform thickness on the surface of the substrate W. Further, the cost and the size of the apparatus can be reduced as compared to the case of providing an independent power source for each feeding wire.

As shown in FIG. 18, it is also possible to provide a ring-shaped intermediate contact 150, extending continuously over the entire circumference, between the central contact 120 and the peripheral contact 122 on the upper surface of the anode 98, and connect a feeding wire 152 extending from the anode of a power source (not shown) to the intermediate contact 150. As with the case shown in FIG. 17, it is possible also in this case to provide a single common power source and to connect a branched feeding wire, extending from the anode of the power source, with an on/off switch interposed therein to the intermediate contact 150.

By thus increasing the number of points for feeding electricity to the anode 98 to thereby more finely adjust an electric current flowing in the anode 98, a plated film having a more uniform thickness can be formed on the surface of a substrate. A plurality of intermediate contacts 150 may be provided so as to more finely control an electric current flowing in the anode 98.

FIG. 19 shows another anode. The anode 160 is comprised of an anode body 162 in the shape of a mesh, such as a triangular lattice, and composed of a material having a high resistivity, for example, a material comprising as the base material a ceramic having a slight electric conductivity, and low-resistance members 164 mounted on and scattered over a surface of the anode body 162. As in this case, a high-resistance material and a low-resistance material may be combined arbitrarily. The use of copper for the low-resistance members 164 can make a soluble high-resistance anode.

According to this embodiment, by disposing the porous structure 110 between the anode 98 and a substrate W held by the substrate holder 36 and impregnating the porous structure 110 with a plating solution, the plating solution between the anode 98 and the substrate W is allowed to have such a high resistance as to make the effect of the sheet resistance of the substrate surface negligible, so that a plated film having a more uniform thickness can be securely formed even when the substrate has a high sheet resistance. It is, however, of course possible not to use such a porous structure.

Though copper is used as an interconnect material, a copper alloy, silver or a silver alloy may be used instead of copper.

According to this embodiment, even when the sheet resistance of a surface of a substrate becomes higher as a seed layer becomes thinner or with the progress toward seed-less substrates which necessitate direct plating on a surface of a barrier layer, a plated film having an enhanced in-plane uniformity can be formed on a surface of a substrate irrespective of the degree of a terminal effect in the substrate surface.

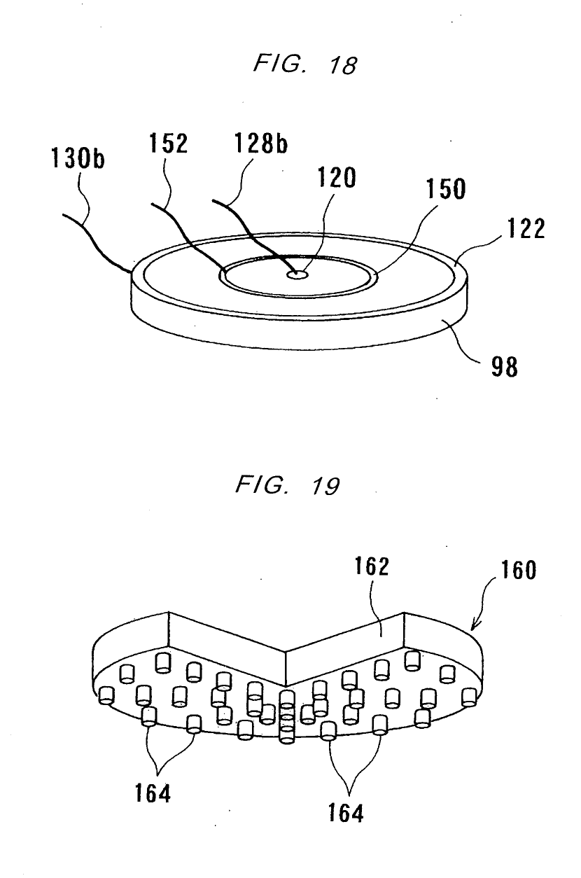

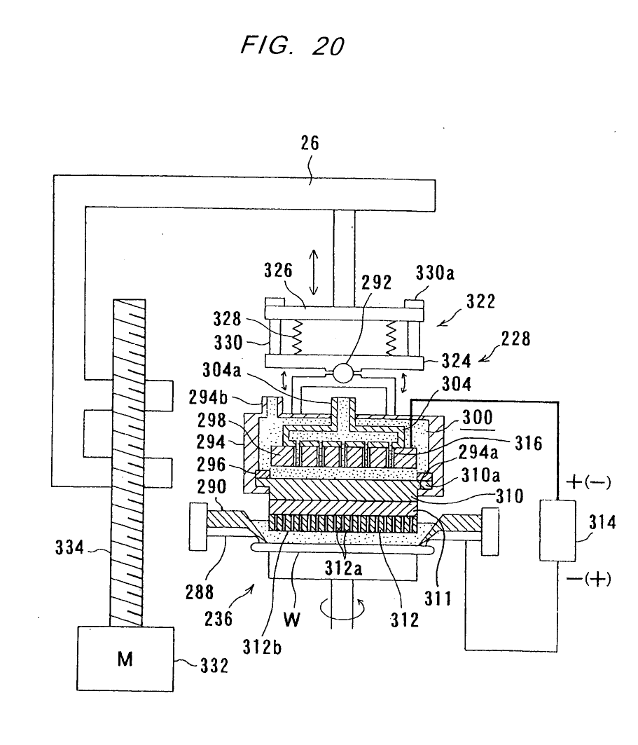

FIGS. 20 and 21 show an electrode head 228 of a plating apparatus according to another embodiment of the present invention. The electrode head 228 includes a housing 294 coupled to the free end of a pivot arm 26 via a ball bearing 292, and a flat plate-like press member 310 comprised of a porous structure, disposed such that it closes the lower-end opening of the housing 294. In particular, the housing 294 has in its lower portion an inwardly-protruding portion 294a, and the press member 310 has at its top a flange portion 310a. The press member 310 is held in the housing 294 with the flange portion 310a engaging the inwardly-protruding portion 294a and a spacer 296 interposed. A hollow plating solution chamber 300 is thus formed in the housing 294.

As with the preceding embodiment, when a substrate holder 236 is raised to the plating position B (see FIG. 7), cathodes 288 are pressed against the peripheral region of a substrate W held by the substrate holder 236 to feed electricity to the peripheral region while the inner end of a sealing member 290 is brought into pressure contact with the peripheral region of the upper surface of the substrate W, thereby water-tightly sealing the contact portion and preventing a plating solution, which has been supplied onto the upper surface (surface to be plated) of the substrate W, from leaking out of the end of the substrate W.

A flat plate-like cushioning material 311 comprised of an elastic porous material is attached, e.g., with an adhesive, to a lower surface of the press member 310, and a flat plate-like contact member 312 comprised of a porous material, having a large number of through-holes 312a extending vertically and linearly through the contact member 312, is attached, e.g., with an adhesive, to a lower surface of the cushioning material 311. Thus, a contact surface (lower surface) 312b, which faces the surface of the substrate W held by the substrate holder 236, of the contact member 312 can be brought into pressure contact with the surface (upper surface) of the substrate W by the press member 310.

The press member 310 may be composed of a porous ceramic, such as alumina, SiC, mullite, zirconia, titania or cordierite, or a hard porous body, such as a sintered body of polypropylene or polyethylene, or a composite thereof, or a woven or non-woven fabric. For example, a porous ceramic plate may be used having a pore diameter of 30 to 200 μm in the case of an alumina ceramic, or not more than 30 μm in the case of SiC, a porosity of 20 to 95%, and a thickness of 1 to 20 mm, preferably 5 to 20 mm, more preferably 8 to 15 mm. According to this embodiment, the press member 310 is composed of a porous alumina ceramic plate, for example, having a porosity of 30% and an average pore diameter of 100 μm. The porous ceramic plate per se is an insulator, but it is constituted to have lower electric conductivity than the electric conductivity of the plating solution by causing the plating solution to enter its interior complicatedly and follow a considerably long path in the thickness direction.

The provision of the press member 310, which can thus have a high electric resistance, in the plating solution chamber 300 can make the effect of the resistance of the seed layer 7 (see FIG. 1A) as small as negligible. Thus, a difference in current density in the surface of the substrate W due to the electric resistance of the substrate surface can be made small, thereby improving the in-plane uniformity of a plated film.

The cushioning material 311 is, for example, polyurethane, polyethylene or polyvinyl alcohol. Specifically, for example, SOFLAS manufactured by AION Co., Ltd, or SUBA manufactured by NITTA Corp. can be used as the cushioning material 311. By interposing the flexible cushioning material 311 between the press member 310 and the contact member 312, the entire contact surface 312b of the contact member 312 can be pressed against the surface of the substrate W at amore uniform pressure, thereby preventing the contact surface 312b of the contact member 312 from separating from the surface of the substrate W locally.

The contact member 312 is composed of, for example, an insulting material, such as polycarbonate, a ceramic, carbon, polyester, glass, silicon, a resist material or a fluorocarbon resin; and Whatman filter paper, Nuclepore filter manufactured by Osmonics, Inc., etc. can be used as the contact member 312. The large number of vertically-extending through-holes 312a provided in the contact member 312 may have a circular cross-sectional shape with a diameter of, for example, not more than 12 μm and may be distributed at a density of 1.00×10⁵ to 1.0×10⁹/cm². In this case, columnar plated films having a diameter of not more than 12 μm will be formed on a surface of a substrate. Such cylindrical plated films can be easily removed by later CMP. Further, by setting the density of the through-holes at 1.0×10⁵ to 1.0×10⁹/cm² and selecting an appropriate combination of hole diameter and density, plating can be effected for all interconnect recesses.

A resist material, such as PMMA, which has undergone fine submicron-processing (formation of through-holes) by performing the lithography technique, can also be used as the contact member 312. In this case, a contact member having a thickness of not more than several hundred μm can be produced.

The Ra value (center-line average roughness), indicative of surface roughness, of the contact surface 312b of the contact member 312 is set at not more than 1 μm. This allows good contact of the contact surface 312b of the contact member 312 with a surface of a substrate W, thus preventing the formation of a gap between the contact surface 312b and the surface of the substrate W upon their contact. This can prevent an extra plated film being formed in a non-interconnect region and imposing a burden on a later CMP processing.

Though not depicted, the through-holes provided in the contact member may be tapered such that the cross-sectional area gradually decreases with distance from the contact surface, i.e., upwardly. Pointed tapered columnar plated films will therefore be formed on the surface of a substrate. When providing such tapered through-holes, e.g., having a large diameter, in the contact member and forming tapered plated films in the through-holes, the plated films can be easily drawn out of the through-holes after plating.

Located above the press member 310, an anode 298 is disposed in the plating solution chamber 300. The anode 298 is mounted to a lower surface of a plating solution introduction pipe 304 disposed above the anode 298. The plating solution introduction pipe 304 has a plating solution introduction inlet 304a to which is connected a plating solution supply pipe extending from the plating solution supply facility 18 (see FIG. 5). Further, a plating solution discharge pipe 306, communicating with the plating solution chamber 300, is connected to a plating solution discharge outlet 294b provided in the upper surface of the housing 294.

The plating solution introduction pipe 304 has a manifold structure so that a plating solution can be supplied uniformly to the surface (surface to be plated) of the substrate W. Thus, a number of narrow tubes 316, which are communicated with the plating solution introduction pipe 304, are coupled to the plating solution introduction pipe 304 at predetermined positions along the long direction of the pipe 304. The anode 298 has narrow holes at positions corresponding to the narrow tubes 316, and the narrow tubes 316 extend downwardly in the narrow holes.

The plating solution, introduced from the plating solution supply pipe 302 into the plating solution introduction pipe 304, passes through the narrow tubes 316 and reaches the upper surface of the press member 310 and fills the plating solution chamber 300, immersing the anode 298 in the plating solution, while the plating solution passes through the press member 310, the cushioning material 311 and the contact member 312 and reaches the lower surface of the contact member 312, and discharged by suction through the plating solution discharge pipe 306.

In order to inhibit the formation of a slime, the anode 298 is composed of copper (phosphorus-containing copper) containing 0.03 to 0.05% of phosphorus. It is, however, possible to use an insoluble metal, such as platinum or titanium, or insoluble electrode comprising metal on which platinum or the like is plated. The use of an insoluble metal or an insoluble electrode is preferred from the viewpoint of no need for replacement. Because of easy passage of plating solution, a net-shaped electrode, e.g., insoluble one, may also be used.

When carrying out plating, the cathode 288 is electrically connected to the cathode of a plating power source 314, and the anode 298 is electrically connected to the anode of the plating power source 314. In this embodiment, the plating power source 314 is designed to be capable of changing the direction of electric current optionally so that the plating apparatus can have an etching function of etching a plated film. Thus, etching of a plated film can be carried out in the presence of a plating solution by reversing the cathode 288 to an anode and reversing the anode 298 to a cathode by the power source 414.

A press mechanism 322 for pressing the contact surface 312b of the contact member 312 against the surface of the substrate W is provided between the ball bearing 292 and the pivot arm 26. In particular, the press mechanism 322 includes a compression coil spring 328 bridging a pair of plates 324, 326 disposed at a distance from each other, and a stopper 330 which is fixed at its one end to the one plate 324 and which has at the other end a head portion 330a which is made in contact with the other plate 326 so as to limit the distance between the pair of plates 324, 326. The pivot arm 26, on the other hand, is designed to be vertically movable by a lifting motor 332 comprised of a servomotor, and a ball screw 334. Instead of the lifting mechanism, it is also possible to use an air-pressure activator.

When the contact member 312 is not in contact with the surface of the substrate W, the electrode head 228 moves vertically (and pivots) together with the pivot arm 26 through the elastic force of the compression coil spring 328. When the pivot arm 26 is lowered after the contact member 312 has come into contact with the surface of the substrate W, the compression coil spring 328 contracts as the pivot arm 26 lowers. The elastic force of the compression coil spring 328 acts on the contact member 312 via the cushioning material 311, so that the contact surface 312b of the contact member 312 presses on the surface of the substrate W. The pressing force of the contact surface 312b can be controlled by controlling the contraction (displacement) of the compression coil spring 328.

The operation of the plating apparatus having the electrode head 228 of this embodiment will now be described.

In non-plating time, the electrode head 228 is in the normal position above the plating solution tray 22 (see FIG. 6), and the contact member 312 is positioned in the plating solution tray 22. Before proceeding to plating, a plating solution is supplied to the plating solution tray 22 and the electrode head 228 while discharging the plating solution by suction through the plating solution discharge pipe 306, thereby carrying out replacement and defoaming of the plating solution present in the press member 310, the cushioning material 311, and the contact member 312.

As with the above-described embodiment, based on a signal indicating the completion of pre-coating of a substrate W which has been carried into the plating apparatus and held by the substrate holder 236, the electrode head 228 is moved from above the plating solution tray 22 to above the plating position. Thereafter, the electrode head 228 is lowered toward the substrate W held by the substrate holder 236, and stopped when the contact surface 312b of the contact member 312 has come to a position closed to but not being into contact with the surface of the substrate W, for example, at a distance of about 0.1 mm to 3 mm from the substrate W. The plating solution is then supplied from the plating solution supply pipe 302 into the electrode head 228, thereby impregnating the press member 310, the cushioning material 311 and the contact member 312 with the plating solution and filling the space between the upper surface (surface to be plated) of the substrate W and the ceiling of the plating solution chamber 300 with the plating solution, as shown in FIG. 20.

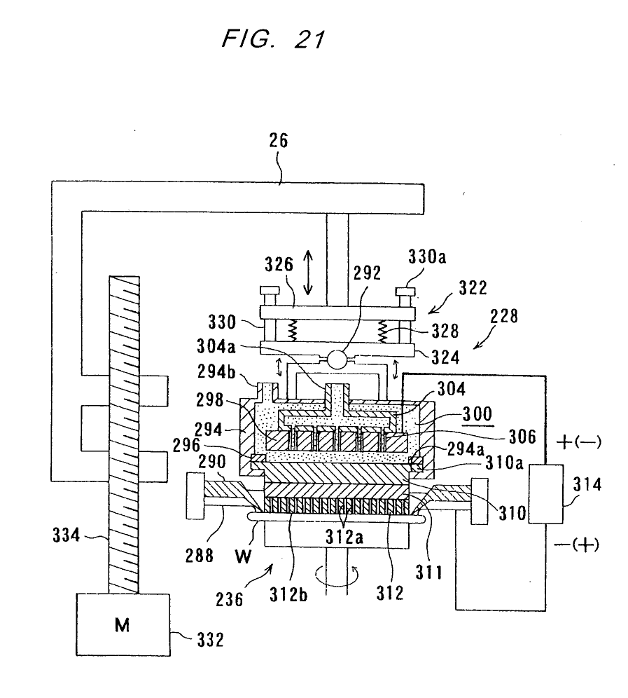

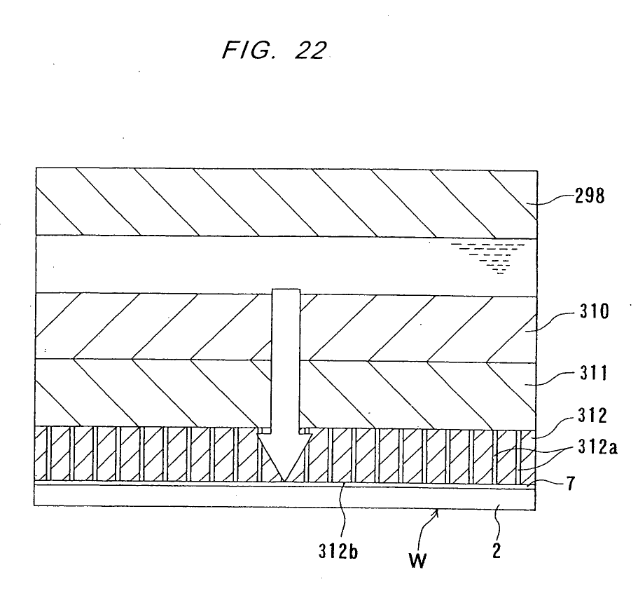

The electrode head 228 is further lowered to bring the contact surface 312b of the contact member 312 into tight contact with the surface of the substrate W, as shown in FIG. 21. As shown particularly in FIG. 22, the contact surface 312b of the contact member 312 makes tight contact with the surface of a seed layer 7 covering an insulating film 2 deposited on the substrate W. The flexible cushioning member 311, interposed between the press member 310 and the contact member 312, enables tight contact of the contact surface 312b of the contact member 312 with the surface of the substrate W without a gap therebetween while preventing the contact surface 312b from separating from the surface (seed layer 7) of the substrate W locally. Thereafter, the cathodes 288 are connected to the cathode of the power source 314 and the anode 298 is connected to the anode of the power source 314 to carry out plating of the surface (surface of the seed layer 7) of the substrate W.

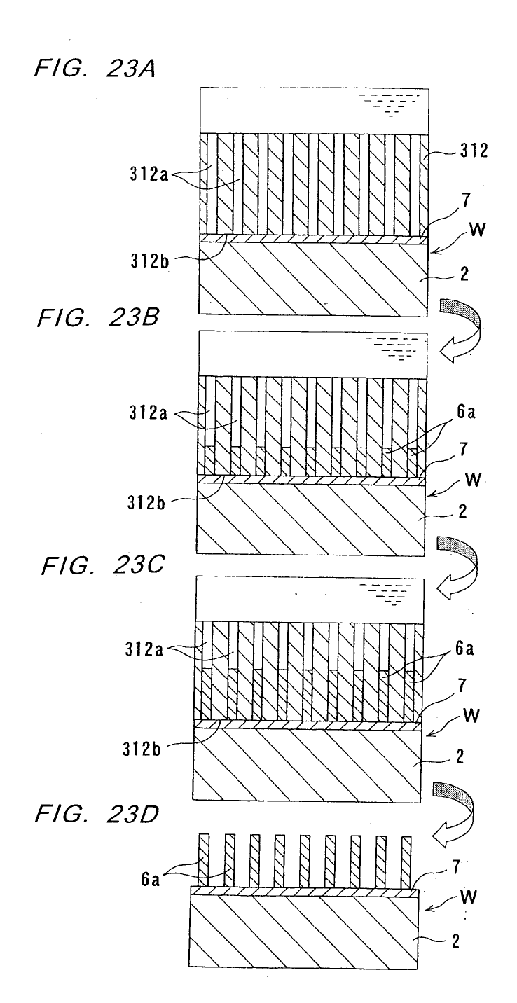

When carrying out plating of the substrate W while keeping the contact surface 312b of the contact member 312, having the large number of vertically-extending through-holes 312a, in contact with the surface of the seed layer 7 of the substrate W, the surface of the seed layer 7 in non-interconnect regions, except portions facing the through-holes 312a provided in the contact member 312, directly contacts the contact surface 312b of the contact member 312 and the plating solution is excluded from the contact area, as shown in FIG. 23A. Accordingly, as shown in FIGS. 23B and 23C, columnar plated films (columnar portions) 6a grow along the through-holes 312a. After plating, the columnar plated films 6a are drawn out of the though-holes 312a of the contact member 312, leaving the columnar plated films 6a on the surface of the seed layer 7, as shown in FIG. 23D.

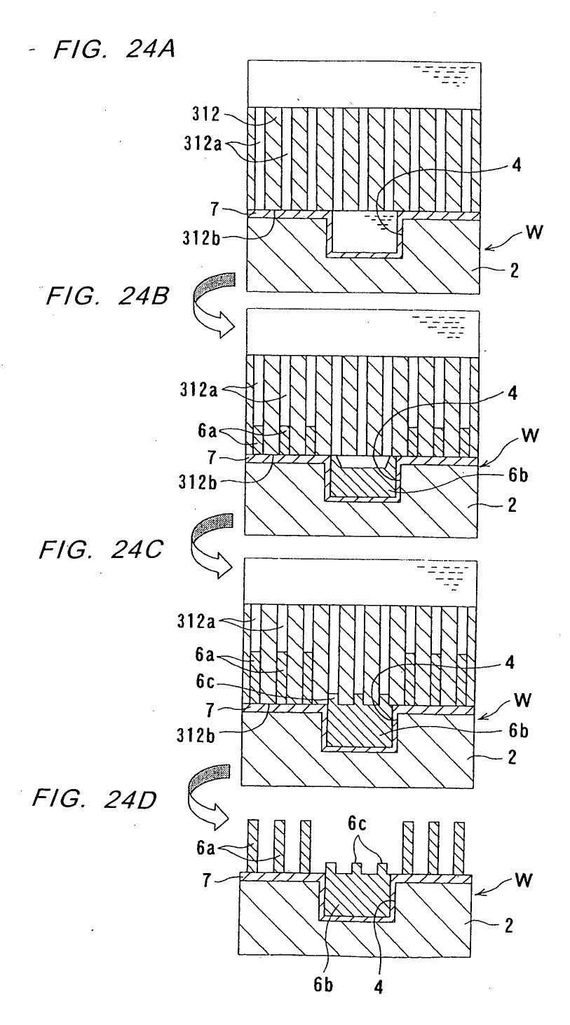

On the other hand, as shown in FIG. 24A, the interior surfaces of interconnect recesses such as trenches 4, formed in the insulating film 2, in interconnect regions are not in contact with the contact surface 312b of the contact member 312 and the recesses such as trenches 4 are filled with the plating solution. Accordingly, as shown in FIG. 24B, a plated film (copper film) 6b first grows such that it fills in the interconnect recesses such as trenches 4. After the plated film 6b has grown to come into contact with the contact surface 312b of the contact member 312, the plated film further grows along the through-holes 312a of the contact member 312 to form columnar plated films (columnar portions) 6c on the surface of the plated film 6b, as shown in FIG. 24D. After plating, the columnar plated films 6c are drawn out of the through-holes 312a of the contact member 312, leaving the columnar plated films 6c on the surface of the plated film 6b embedded in the interconnect recesses such as trenches 4.

Foots of the columnar plated films (columnar portions) 6a, 6c formed in the non-interconnect regions and the interconnect regions of the substrate lie on the same level. Further, by providing through-holes 312a each having a circular cross-sectional shape with a diameter of not more than 12 μm in the contact member 312, each of the columnar plated films 6a, 6c formed on the surface of the substrate have a cylindrical shape having a diameter of not more than 12 μm. Such cylindrical plated films 6a, 6b can be easily removed by later CMP. Further, this can prevent a case in which a cylindrical plated film 6c is too large compared to an interconnect recess, such as a trench 4, to form a cylindrical plated film 6c in the interconnect region.

FIGS. 31 and 32 are schematic diagrams of a plated film as formed by carrying out plating of a surface of a substrate while keeping a contact member, having linearly-extending through-holes, in contact with the surface of the substrate in the above-described manner. FIGS. 31 and 32 show the formation of cylindrical plated films (columnar portions) standing together in large numbers.

After the completion of plating, the electrode head 228 is raised and pivoted to return it to above the plating solution tray 22, and the electrode head 228 is lowered to the normal position. The substrate after plating is then subject to the same processings as in the preceding embodiment, and is returned to the loading/unloading section 10 (see FIG. 5).

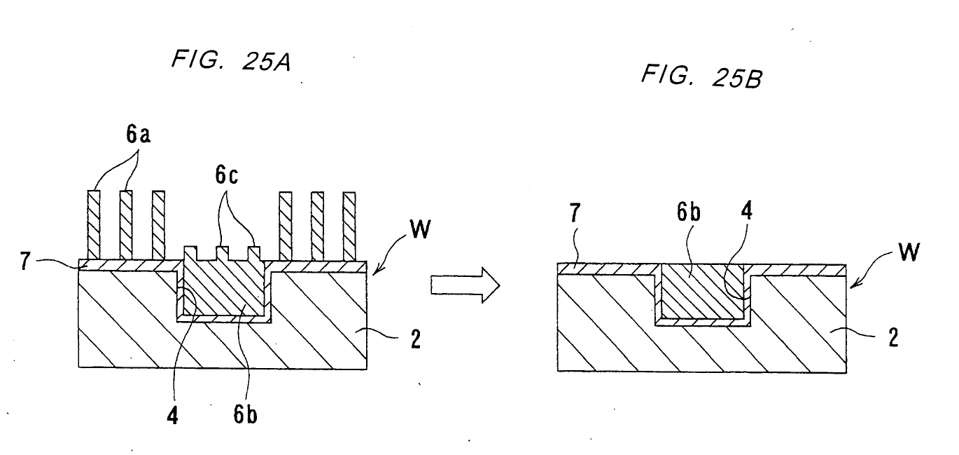

Thereafter, the substrate W is transported to a CMP apparatus. The surface of the substrate W is polished by the CMP apparatus to first remove the numerous columnar plated films (columnar portions) 6a, 6c shown in FIG. 25A, thereby flattening the surface of the substrate W, as shown in FIG. 25B. Since the foots of the numerous columnar plated films 6a, 6b lie on the same level, the plated films 6a, 6b can be easily removed with a relatively small force, i.e., by a low-pressure high-speed CMP processing. After the removal of the numerous columnar plated films 6a, 6c, the surface of the plated film takes on a flat surface with few irregularities, which is easier to polish with CMP as compared to a conventional plated film with surface irregularities.

The above-described plating process relates to the case where interconnect recesses, such as trenches 4, are relatively shallow. In the case where interconnect recesses, such as trenches 4, are relatively deep, on the other hand, columnar plated films can grow to a considerable height during the period of time for the interconnects to be filled with e.g. copper and, because of increased adhesion between the contact member and the surface of the substrate due to increased anchor effect, the contact member can be damaged upon drawing the columnar plated films out of the contact member.

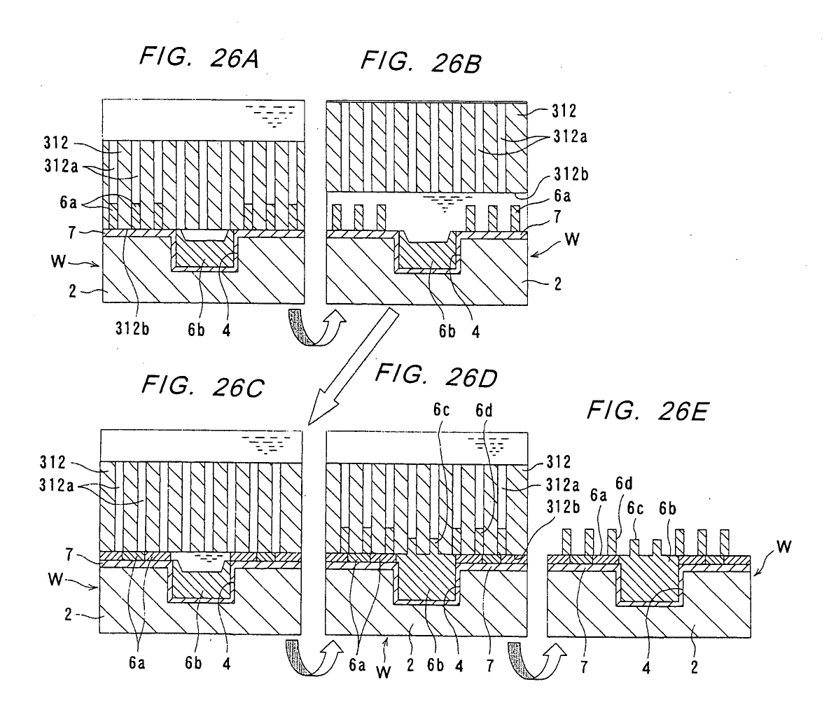

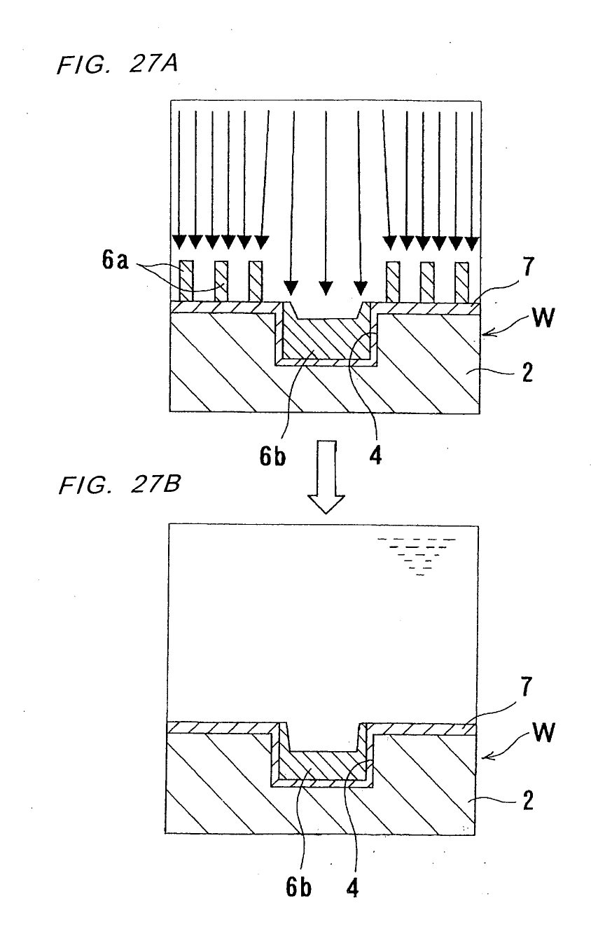

FIGS. 26A through 26E illustrate, in a sequence of process steps, a plated film-forming method which makes it possible to fill interconnect recesses, such as trenches 4, e.g. with copper and easily draw columnar plated films out of a contact member without damage to the contact member.

First, as with the above-described embodiment, plating of a substrate W is carried out while keeping the contact surface 312b of the contact member 312, having the large number of through-holes 312a, in tight contact with the surface seed layer 7 of the substrate W, thereby forming columnar plated films (columnar portions) 6a in the non-interconnect regions and forming a plated film 6b in interconnect recesses, such as trenches 4, to fill the recesses with the plated film, as shown in FIG. 26A. The cathode 288 and the anode 298 are disconnected from the power source 314, according to necessity, and then the electrode head 228 is raised, thereby drawing the columnar plated films 6a out of the contact member 312, as shown in FIG. 26B. Thereafter, at least one of the electrode head 228 and the substrate holder 236 is rotated so as to change the relative position between the contact surface 312b of the contact member 312 and the surface of the substrate W.

Next, as shown in FIG. 26C, the electrode head 228 is lowered again to again bring the contact surface 312b of the contact member 312 into tight contact with the surface seed layer 7 of the substrate w. Upon the contact, the contact member 312 pushes down the columnar plated films 6a. Thereafter, the cathodes 288 and the anode 298 are connected to the plating power source 314 to carry out plating of the substrate W, thereby forming second columnar plated films (columnar portions) 6d (see FIG. 26D) on the fallen columnar plated films 6a while growing the plated film 6b embedded in the interconnect recesses such as trenches 4. Though in this embodiment, the operation of pushing down the columnar plated films 6a with the contact member 312 and then carrying out additional plating is carried out once, the operation may be repeated a plurality of times, according to necessity. This makes it possible to gradually decrease a level difference in the surface irregularities of a plated film without damage to the contact member 312.

The plated film 6b in the interconnect recesses, such as trenches 4, grows to come into contact with the contact surface 312b of the contact member 312. Plating is terminated when columnar plated films 6c, which have grown along the through-holes 312a of the contact member 312, are formed on the surface of the plated film 6b, as shown in FIG. 26D. After plating, the columnar plated films 6c, 6d are drawn out of the through-holes 312a of the contact member 312, as shown in FIG. 26E.

According to this method, the columnar plated films 6c, 6d, which have been formed on the surface of plated film when embedding of the plated film, e.g., copper film, in the interconnect recesses such as trenches 4 is completed, can be made relatively low. Such columnar plated films 6c, 6d can be easily drawn out of the contact member 312 without damage to the contact member 312. In the case of this method, while the plated film 6b formed in the interconnect recesses, such as trenches 4, is dense, the plated films 6a, 6d formed in the non-interconnect regions can contain voids because some gaps can be formed between the fallen columnar plated films 6a. This, however, poses no problem because the plated films formed in the non-interconnect regions will be removed by the next-step CMP processing.

When a plating apparatus is used which, like the plating apparatus of this embodiment, uses such a power source as the power source 314 that is capable of changing the direction of electric current optionally, and thus has an etching function of etching a plated film, it is possible to carry out plating in multiple stages and carry out etching of a plated film after each plating step.

Thus, for example, after drawing the columnar plated films 6a out of the contact member 312 by raising the electrode head 228, as shown in FIG. 26B, etching of the plated films 6a, 6b is carried out in the presence of the plating solution by reversing the cathodes 288 to anodes and reversing the anode 298 to a cathode by the plating power source 314, as shown in FIG. 27A. When carrying out etching in this manner, the flow of electric current is concentrated in the protruding columnar plated films 6a, whereby the columnar plated films 6a are etched preferentially than the plated film 6b embedded in the interconnect recesses such as trenches 4. Accordingly, most of the plated film 6b embedded in the interconnect recesses, such as trenches 4, remains after the columnar plated films 6a are completely removed, as shown in FIG. 27B.

After the removal of the columnar plated films 6a, the next plating is carried out. By repeating this series of processings a plurality of times according to necessity, a level difference in the surface irregularities of a plated film can be gradually decreased without damage to the contact member 312 and columnar plated films, which have been formed on the surface of a plated film when embedding of the plated film, e.g. copper film, in the interconnect recesses, such as trenches 4, is completed, can be made relatively low. Such columnar plated films can be drawn out of the contact member without damage to the contact member.

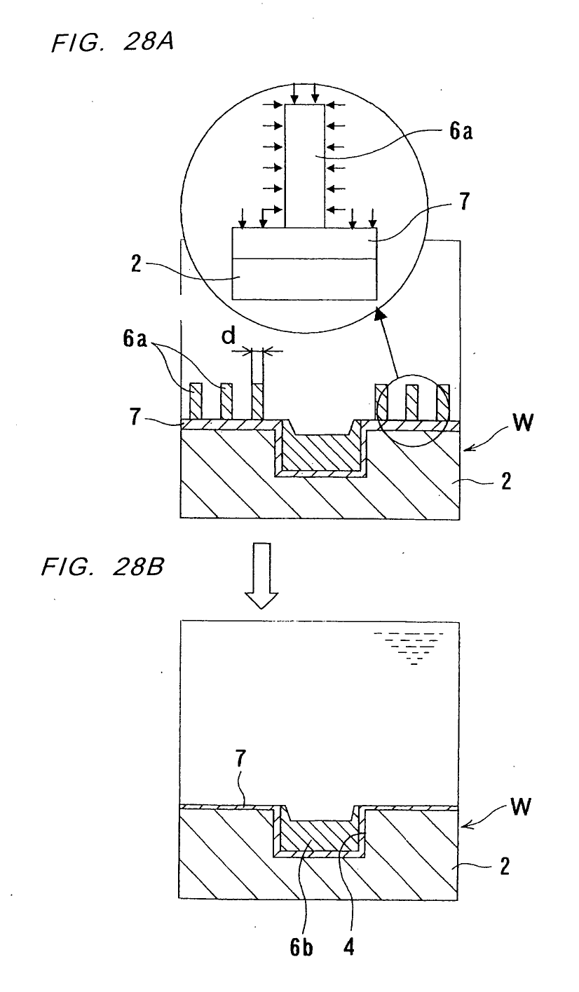

In the case where the columnar plated films 6a are circular films having a diameter d, as shown in FIG. 28A, etching may be carried out under isotropic-etching conditions by applying the reverse electric field (reverse electrolysis) to that of plating between the anode and the surface of the substrate so as to etch away those parts of the columnar plated films 6a which correspond to half of the thickness, i.e., d/2. This makes it possible to etch away the columnar plated films 6a irrespective of their heights, as shown in FIG. 28B.

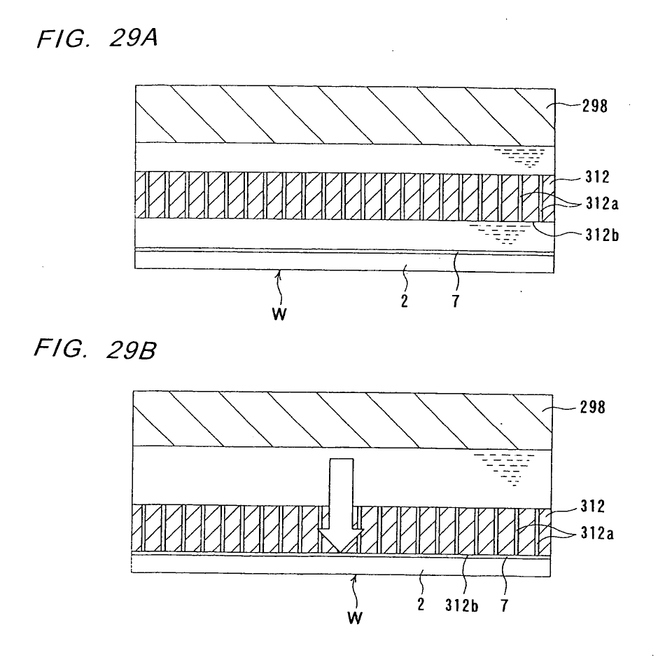

FIG. 29 shows the main portion of a plating apparatus according to yet another embodiment of the present invention. As shown in FIG. 29A, the plating apparatus of this embodiment uses the contact member 312, having a large number of through-holes 312a therein, singly between the anode 298 and a surface of a substrate W, and brings the contact surface (lower surface) 312b of the contact member 312 into tight contact with the surface of the substrate W, i.e., the surface of the seed layer 7 covering the insulating film 2 in carrying out plating.

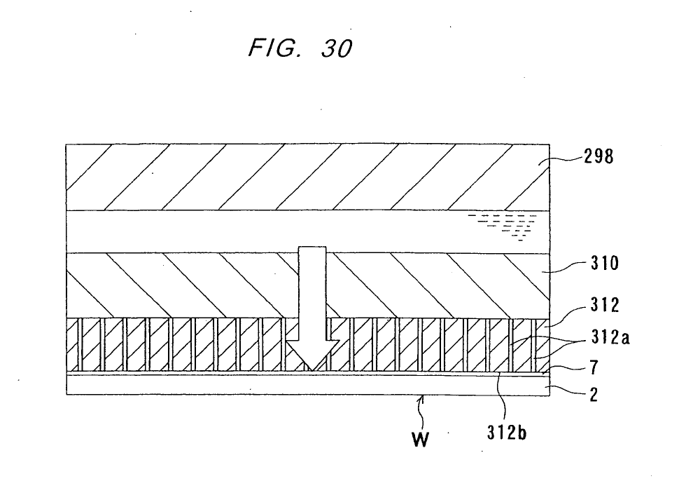

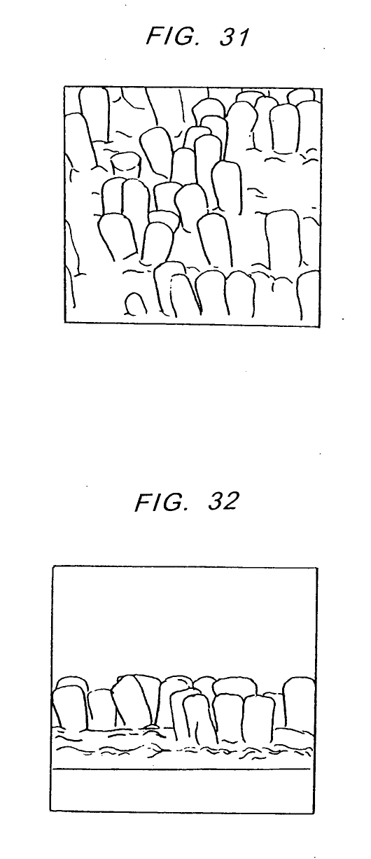

FIG. 30 shows the main portion of a plating apparatus according to yet another embodiment of the present invention. In the plating apparatus of this embodiment, the contact member 312, having a large number of through-holes 312a therein, is mounted directly to the lower surface of the press member 310 without interposing a cushioning material between them.

Though copper is used as an interconnect material in the plating method of this embodiment, a copper alloy, silver or a silver alloy may also be used instead of copper.

According to this embodiment, columnar plated films whose foots lie on the same level can be formed while filling interconnect recesses, such as trenches, with a plated film. Such columnar plated films can be easily removed in the next CMP step, and a surface of a plated film after the removal of the columnar plated films is relative flat. The burden on the CMP processing can thus be reduced.

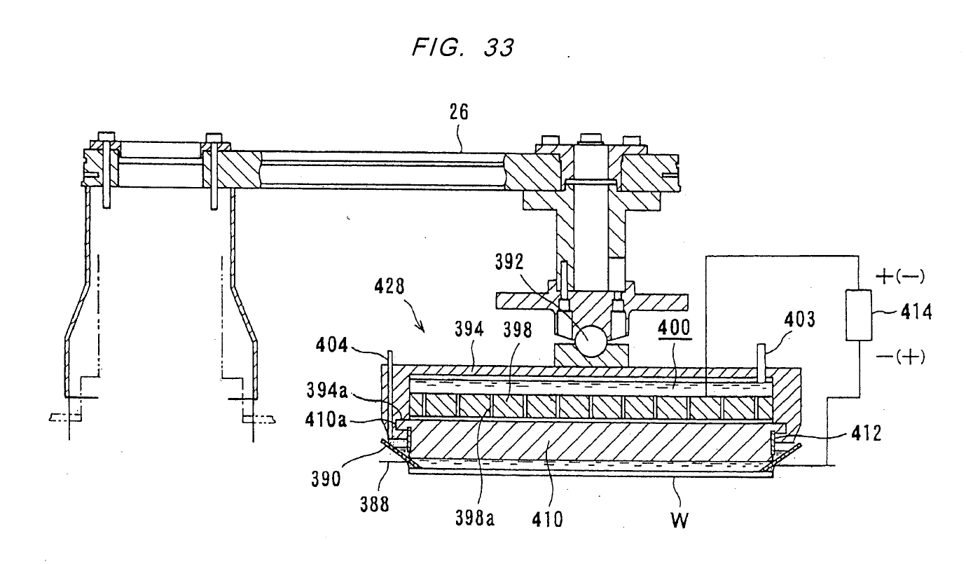

FIG. 33 shows an electrode head 328 of a plating apparatus according to yet another embodiment of the present invention. As with the above-described embodiments, this plating apparatus can be employed also as an electrolytic processing apparatus such as an electrolytic etching apparatus. The following description mainly illustrates the use of this apparatus as a plating apparatus, also referring to the case of using it as an electrolytic etching apparatus according to necessity.

As shown in FIG. 33, the plating apparatus (electrolytic processing apparatus) includes an electrode holder 394 coupled via a ball bearing 392 to the free end of a pivot arm 26, and a porous structure 410 disposed such that it closes the lower-end opening of the electrode holder 394. In particular, the electrode holder 394 has the shape of a downwardly-open bottomed cup and has a recessed portion 394a at a lower position in the inner peripheral surface. The porous structure 410 has at its top a flange portion 410a that fits in the recessed portion 394a. The porous structure 410 is held in the electrode holder 394 by fitting the flange portion 410a into the recessed portion 394a. A hollow plating solution chamber 400 is thus formed in the electrode holder 394.

As with the preceding embodiment, when a substrate holder (not shown) is raised to the plating position B (see FIG. 7), cathodes 388 (first electrode) are pressed against a peripheral region of a substrate W held by the substrate holder to feed electricity to the peripheral region while the inner end of a sealing member 390 is brought into pressure contact with the peripheral region of the upper surface of the substrate W, thereby water-tightly sealing the contact portion and preventing a plating solution, which has been supplied onto the upper surface (surface to be plated) of the substrate W, from leaking out of the end of the substrate W.

The porous structure 410 has a pressure loss (as measured at room temperature by passing nitrogen gas at a linear velocity of 0.01 m/s through 14 mm-thick porous structure) of not less than 500 kPa, preferably not less than 1000 kPa, more preferably not less than 1500 kPa, or an apparent porosity (in accordance with JIS R 2205) of not more than 19%, preferably not more than 15%, more preferably not more than 10%, and has a resistivity of not less than 1.0×10⁵ Ω·cm. The porous structure 410 is composed of silicon carbide, silicon carbide with oxidation-treated surface, alumina, or a plastic, such as a sintered body of polypropylene or polyethylene, or a combination thereof. A thickness of the porous structure 410 is generally about 1 to 20 mm, preferably about 5 to 20 mm, more preferably about 8 to 115 mm. The porous structure 410 used in this embodiment is composed of silicon carbide (SiC), having a pressure loss of 1500 kPa or an apparent porosity of 10% and having a resistivity of 1.0×10⁶ Ω·cm. Though the porous structure 410 per se is an insulating material, but it is constituted to have lower electric conductivity than the electric conductivity of the plating solution by causing the plating solution to enter its interior complicatedly and follow a considerably long path in the thickness direction.

By providing the porous structure 410 of, e.g., silicon carbide, having a pressure loss of not less than 500 kpa, preferably not less than 1000 kPa, more preferably, not less than 1500 kPa or an apparent porosity of not more than 19%, preferably not more than 15%, more preferably not more than 10% and having a resistivity of not less than 1.0×10⁵Ω·cm, in the plating solution chamber 400, and allowing the porous structure 410 to have a high electric resistance, it becomes possible to make the effect of the electric resistance of a seed layer 7 (see FIG. 1A) of a substrate W as small as negligible even when the substrate W has a large area and the seed layer 7 is thin and has a large electric resistance. Thus, a difference in current density in the surface of the substrate W due to the electric resistance of the substrate surface can be made small, thereby improving the in-plane uniformity of a plated film.

In the plating solution chamber 400 and located above the porous structure 410 is disposed an anode (second electrode) 398 having a large number of vertically-extending through-holes 398a. The anode (second electrode) 398 will serve as a cathode during electrolytic etching. The electrode holder 394 has a plating solution discharge outlet 403 for discharging by suction a plating solution in the plating solution chamber 400. The plating solution discharge outlet 403 is connected to a plating solution discharge pipe extending from the plating solution supply facility 18 (see FIG. 5). Further, a plating solution injection section 404, positioned beside the anode 398 and the porous structure 410 and vertically penetrating the peripheral wall of the electrode holder 394, is provided within the peripheral wall of the electrode holder 394. According to this embodiment, the plating solution injection section 404 is comprised of a tube with a nozzle-shaped lower end, and connected to a plating solution supply pipe extending from the plating solution supply facility 18 (see FIG. 5).

The plating solution injection section 404 is to inject a plating solution from the side of the anode 398 and the porous structure 410 into the space between the substrate W and the porous structure 410 when the substrate holder is in the plating position B (see FIG. 7) and the electrode head 328 is in such a lowered position that the distance between the substrate W held by the substrate holder and the porous structure 410 is, for example, about 0.5 to 3 mm. The lower-end nozzle portion opens to the space between a sealing member 390 and the porous structure 410. A rubber shielding ring 412 is attached to a circumferential surface of the porous structure 410 for electrical shielding the circumferential surface of the porous structure 410.

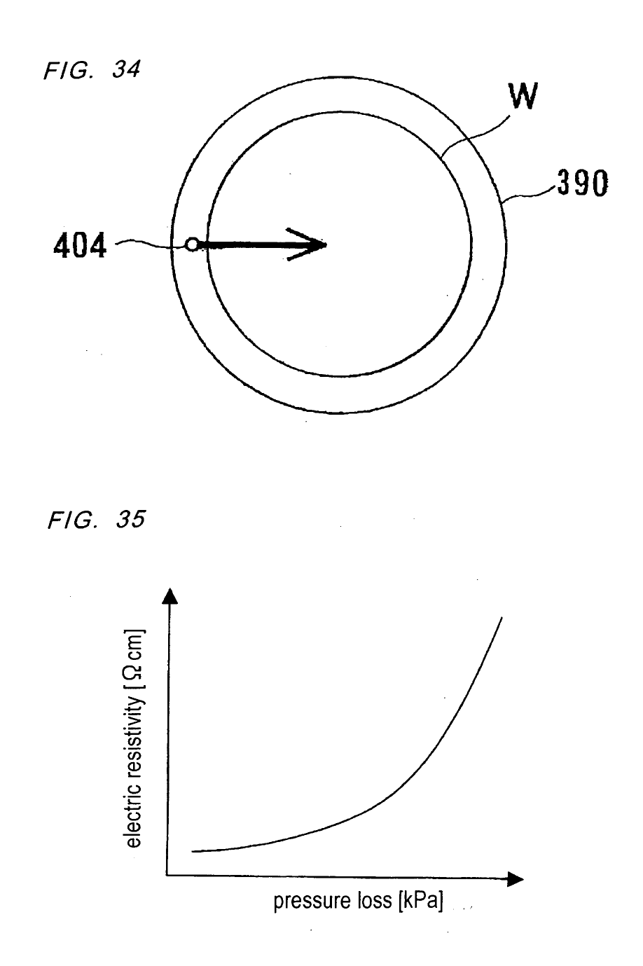

The plating solution, injected from the plating solution injection section 404 at the time of injection of the plating solution, flows in one direction along the surface of the substrate W, as shown in FIG. 34, and by the flow of plating solution, air in the space between the substrate W and the porous structure 410 is forced out of the space. The space is thus filled with the fresh, composition-adjusted plating solution injected from the plating solution injection section 404, and the plating solution is stored in the space defined by the substrate W and the sealing member 390.

By thus injecting the plating solution from the side of the anode 398 and the porous structure 410 into the space between the substrate W and the porous structure 410, filling of plating solution can be carried out without provision of, for example, an electrolytic solution supply tube composed of an insulating material, which may disturb the electric field distribution, within the porous structure 410. This can make the electric field distribution uniform over an entire surface of a substrate even when the substrate has a large area. Furthermore, the plating solution held in the porous structure 410 can be prevented from leaking out of the porous structure 410 upon the injection of a fresh plating solution. Accordingly, the fresh composition-adjusted plating solution can be supplied into the space between the substrate W held by the substrate holder and the porous structure 410.

In the case of this electroplating apparatus, a reaction can occur upon filling of a plating solution, and the reaction can make embedding of a plated film impossible, or can partly change the properties of a plated film. In order to prevent this, it is desirable to inject a plating solution at a linear velocity of 0.1 to 10 m/s and finish filling of the plating solution within 5 seconds e.g. for a 300-mm wafer. The plating solution injection section 404 is preferably configured to meet this requirement.

In this embodiment, the anode 398 is composed of copper (phosphorus-containing copper) containing 0.03 to 0.05% of phosphorus in order to inhibit the formation of a slime. It is, however, possible to use an insoluble anode.

In this embodiment, the cathodes (first electrode) 388 are electrically connected to the cathode of the plating power source 414 and the anode (second electrode) 398 is electrically connected to the anode of the plating power source 414. When the apparatus is used as an etching apparatus, the first electrode 388 is connected to the anode of the power source and the second electrode 398 is connected to the cathode of the power source.

As described above, the first electrode 388 is made serve as a cathode and the second electrode 398 is made serve as an anode by the power source 414. When the substrate holder is in the plating position B (see FIG. 7), the electrode head 328 is lowered until the distance between the substrate W held by the substrate holder and the porous structure 410 becomes, for example, about 0.5 to 3 mm. Thereafter, a plating solution is injected from the plating solution injection section 404 into the space between the substrate W and the porous structure 410, so that the plating solution fills the space and is stored in the space defined by the substrate W and the sealing member 390 for plating.

Electrolytic etching can be carried out instead of the plating by using an electrolytic etching solution instead of the plating solution and making the first electrode 388 serve as an anode and the second electrode 398 serves as a cathode by the power source 414.

According to this embodiment, the electric resistance between the anode (second electrode) 398 and a substrate W in contact with the cathodes (first electrode) 388 can be made still larger by using, as the porous structure 410 disposed between the cathode (first electrode) 388 and the anode (second electrode) 398, one having a pressure loss of not less than 500 kPa, preferably not less than 1000 kPa, more preferably not less than 1500 kPa or an apparent porosity of not more than 19%, preferably not more than 15%, more preferably not more than 10%. This can further reduce the effect of the electric resistance of a surface seed layer 7 of a substrate W and make the electric field more uniform over the entire surface of the substrate W even when the substrate W has a large area and the seed layer 7 is thin and has a large electric resistance. Accordingly, a plated film having a high in-plane uniformity of film thickness can be formed on the surface of the substrate W.

This is for the following reasons. FIG. 35 shows the relationship between the pressure loss (kPa) and the electric resistivity (Ω·cm) of porous structure 410 of silicon carbide, as obtained by using porous structures 410 having various pressure losses in the range of 100-2800 kPa; and measuring the voltage between the cathodes (first electrode) 388 and the anode (second electrode) 398 when a predetermined current is passed between them, and calculating the electric resistivity of the porous structure 410 from the relationship between the measured voltage and the current. The electric resistivity of a porous structure refers to the electric resistivity of the porous structure with its interior filled with a plating solution, and can be determined by the following equation 1:
Electric resistivity=(A₁−A₀)×S/L(Ω·cm) (1)

wherein A₀: Slope of current-voltage relationship as obtained when only a plating solution is present between the electrodes (Ω)
A₁: Slope of current-voltage relationship as obtained when a porous structure is provided between the electrodes (Ω)
S: Area of the opening of shielding ring (cm²)
L: Thickness of porous structure (cm)

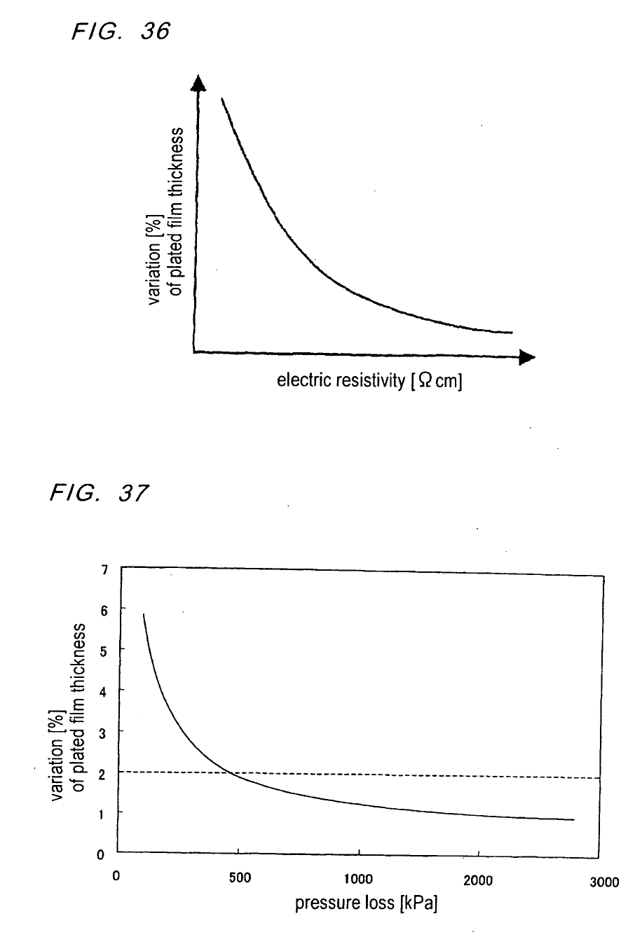

FIG. 36 shows the relationship between the electric resistivity (Ω·cm) of porous structure 410 and variation (%) (relative standard deviation) of plated film thickness in a substrate (wafer) surface (in the radial direction), as obtained by a simulation calculation. FIG. 37 shows the relationship between the pressure loss of porous structure 410 and variation of plated film thickness, obtained from the data of FIGS. 35 and 36.

The simulation is made based on assumed copper plating of a surface (upper surface) of a 300 mm-diameter silicon substrate held face up. The assumed substrate has a thin ruthenium (Ru) film as a conductive layer (seed layer) formed over the upper surface (surface to be plated), and the assumed plating solution contains copper ions, sulfuric acid, chloride ions and additives (an inhibitor, a promoter and a flattening agent) and has an electric conductivity of 23 S/m. This holds also for the below-described simulation.

A plated film is required to have such an in-plane uniformity of film thickness that its variation (relative standard deviation) is not more than 2%. As apparent from FIG. 37, the use of a porous structure 410 having a pressure loss of not less than 500 kPa can control variation (relative standard deviation) of plated film thickness within 2.0%, meeting the in-plane uniformity requirement for plated film thickness. The use of a porous structure 410 having a pressure loss of not less than 1000 kPa can control variation (relative standard deviation) of plated film thickness within 1.2%, thus further enhancing the in-plane uniformity of plated film thickness. The use of a porous structure 410 having a pressure loss of not less than 1500 kPa is preferred for further reducing variation of plated film thickness.

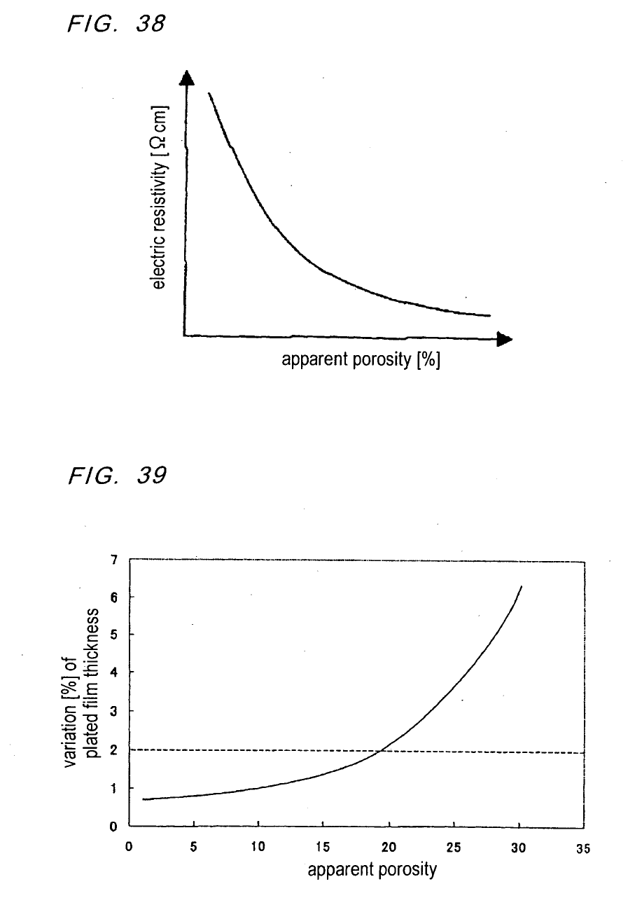

FIG. 38 shows the relationship between the apparent porosity (%) and the electric resistivity (Ω·cm) of porous structure 410 of alumina, as obtained by using porous structures 410 having various apparent porosities in the range of 1-30%; and measuring the voltage between cathodes (first electrode) and an anode (second electrode) when a predetermined current is passed between them, and calculating the electric resistivity of the porous structure from the relationship between the measured voltage and the current as with the above-described manner. FIG. 39 shows the relationship between the apparent porosity of porous structure 410 and variation of plated film thickness, obtained from the data of FIGS. 36 and 38.

A plated film is required to have such an in-plane uniformity of film thickness that its variation (relative standard deviation) is not more than 2%. As is apparent from FIG. 39, the use of a porous structure 410 having an apparent porosity of not more than 19% can control variation (relative standard deviation) of plated film thickness within 2.0%, thus meeting the in-plane uniformity requirement for plated film thickness. It is preferred to use a porous structure 410 having an apparent porosity of not more than 15%, more preferably not more than 10% for further reducing variation of plated film thickness.

The porous structure 410 has a resistivity of not less than 1.0×10⁵ Ω·cm for the following reasons. FIG. 40 shows the relationship between current and voltage, as observed when carrying out copper plating of a substrate by using porous structures 410 of silicon carbide having an apparent porosity of 15% and a resistivity of 1.0×10³ to 1.0×10⁶ Ω·cm, and passing electric current between the cathodes (first electrode) 388 and the anode (second electrode) 398. As is apparent from FIG. 40, there is a proportional relationship between current and voltage when the resistivity of the porous structure 410 (itself) is not less than 1.0×10⁵ Ω·cm. It has been confirmed that the proportional relationship is reproducible. It has also been confirmed that when the resistivity of the porous structure 410 is not more than 1.0×10⁴, voltage rapidly rises as current exceeds a certain level and, in addition, there is no reproducible relationship between current and voltage.

Thus, the use of a porous structure 410 having a resistivity of not less than 1.0×10⁵ makes it possible to carry out plating with voltage highly-reproducible and stable to plating current. Taking account of high-current plating, it is preferred to use a porous structure 410 having a resistivity of not less than 1.0×10⁶.

It is also possible to use a porous structure 410 whose overall resistance A (Ω), which is the electric resistance between the upper and lower surfaces of the porous structure 410 with its interior filled with a plating solution (electrolytic solution), is adjusted to not less than 0.02 time the sheet resistance (electric resistance) B (Ω/□) of a surface seed layer (conductive layer) 7 of a substrate W (A/B≧0.02).

This can also make the overall electric resistance A (Ω) between the upper and lower surfaces of the porous structure 410 with its interior filled with the plating solution (electrolytic solution) sufficiently large with respect to the sheet resistance B (Ω/□) of the surface seed layer 7 of the substrate W such that the sheet resistance B is negligible, thereby making the electric field more uniform over the entire surface of the substrate and forming a plated film having higher in-plane uniformity of film thickness on the surface of the substrate. This is for the following reasons.

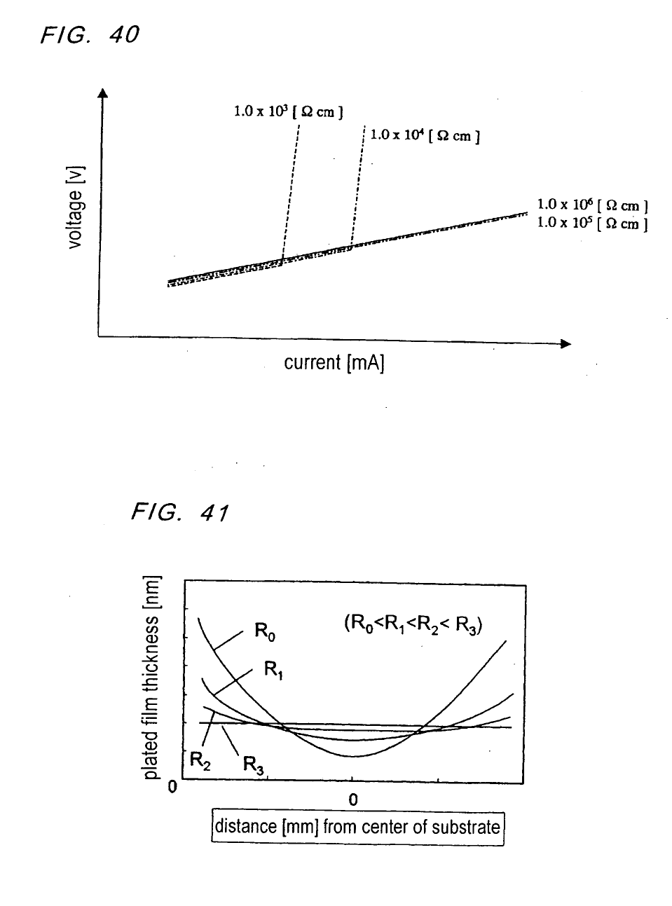

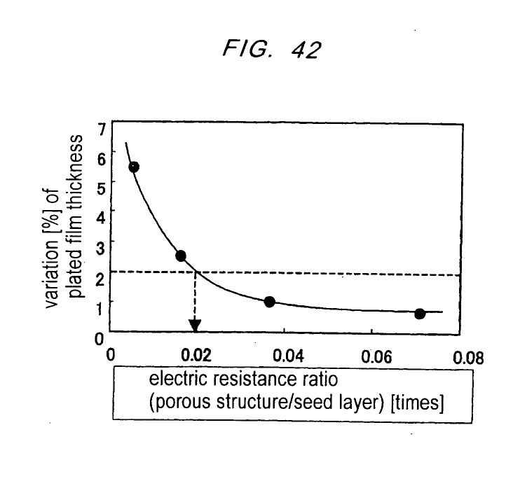

FIG. 41 shows the results of simulation analysis of plated film thickness in a substrate surface (in the radial direction), as analyzed by changing the ratio R (=A/B): the overall electric resistance A (Ω) between the upper and lower surfaces of a porous structure with its interior filled with a plating solution/the sheet resistance B (Ω/□) of a seed layer (conductive layer) of ruthenium formed on a 300 mm-diameter silicon substrate, in the range of 0.002-1 (R₀<R₁<R₂<R₃). FIG. 42 shows the relationship between the electric resistance ratio R and variation of plated film thickness, calculated from the analytical results shown in FIG. 41.

A plated film is required to have such an in-plane uniformity of film thickness that its variation (relative standard deviation) is not more than 2%. As is apparent from FIG. 42, variation (relative standard deviation) of plated film thickness can be controlled within 2% to meet the in-plane uniformity requirement for plated film thickness by adjusting the overall electric resistance A between the upper and lower surfaces of the porous structure with its interior filled with a plating solution to not less than 0.02 time the sheet resistance (electric resistance) B of seed layer (A/B≧0.02). It is preferred to adjust the overall electric resistance A between the upper and lower surfaces of the porous structure with its interior filled with a plating solution to not less than 0.04 time the sheet resistance (electric resistance) B of seed layer for further reducing variation of plated film thickness.

In operation of the plating apparatus of this embodiment having the electrode head 328, similarly to the above-described plating apparatus having the electrode head 28 shown in detail in FIG. 15, the electrode head 328 is lowered until the porous structure 410 comes to a position as close as about 0.5 mm to 3 mm to the surface of a substrate W, a given voltage is applied from the plating power source 414 to between the cathodes 388 and the anode 398, and a plating solution is injected from the plating solution injection section 404 into the space between the substrate W and the porous structure 410 to fill the space with the plating solution, thereby to carry out plating of the surface (surface to be plated) of the substrate W. The other processings are the same as those of the above-described plating apparatus having the electrode head 28, and hence a description thereof is omitted.

Though the electrolytic processing apparatus is employed for electroplating in this embodiment, the apparatus, as it is, can be employed for carrying out electrolytic etching by reversing the direction of electric current, i.e., reversing the polarities of the power source. Uniform etching can be effected by such electrolytic etching. It is known in a plating process for copper interconnects in an LSI to carry out electrolytic etching in the course of the plating process by reverse electrolysis processing. For example, the following processing can be carried out using the present apparatus: Plating is carried out at a current density of 20 mA/cm² for 7.5 seconds to form a copper plated film with a thickness of 50 nm; the polarities of the power source is reversed to carry out etching at a current density of 5 mA/cm² for 20 seconds, thereby etching off the copper plated film by 33 nm, and then final plating is carried out. It has been confirmed that this processing can effect uniform etching and improve embedding of the copper plated film.

Though the porous structure 410 used in this embodiment has a pressure loss of 1500 kPa or an apparent porosity of 10% and has a resistivity of 1.0×10⁶ Ω·cm, and is composed of silicon carbide, it is also possible to use a porous structure composed of e.g. silicon carbide, having an adjusted pressure loss of not less than 500 kPa, preferably not less than 1000 kP, more preferably not less than 1500 kPa, or an adjusted apparent porosity of not more than 19%, preferably not more than 15%, more preferably not more than 10%, and preferably having an adjusted resistivity of not less than 1.0×10⁵ Ω·cm, or a porous structure of which at least one of the bulk specific gravity and the water absorption is adjusted, in carrying out plating of a substrate by applying a voltage between the cathodes (first electrode) 388 and the anode (second electrode) 398. This makes it possible to carry out electrolytic processing, such as electroplating, of a substrate with the electric field at the surface of the substrate adjusted to the desired state so that the substrate after electrolytic processing can have a processed surface in the intended state.

It is also possible to use a porous structure 410 whose overall electric resistance A (Ω), i.e., the resistance between the upper and lower surfaces of the porous structure 410 with its interior filled with a plating solution (electrolytic solution), is adjusted to not less than 0.02 time the sheet resistance (electric resistance) B (Ω/□) of a surface seed layer (conductive layer) 7 of a substrate W (A/B≧=0.02).

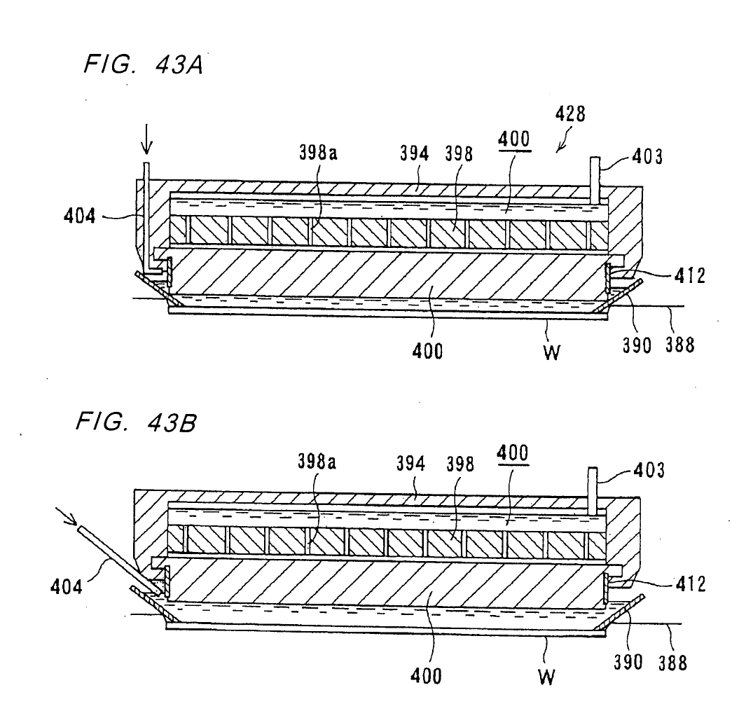

FIGS. 43A and 43B show variations of the electrode head. The electrode head of FIG. 43A uses, as the plating solution injection section 404 which is connected to the above-described plating solution supply pipe and which supplies a plating solution into the space between the substrate W in the plating position and the porous structure 410, a tube which, at a lower point, is bent orthogonally inwardly so as to jet the plating solution inwardly in the radial direction of the substrate W and force the plating solution to collide against the circumferential surface of the porous structure 410. In the electrode head of FIG. 43B, the tubular plating solution injection section 404 disposed beside the porous structure 410 is tilted such that the lower-end nozzle is oriented inwardly and obliquely downwardly so as to create with the plating solution jetted from the nozzle a flow of the plating solution that flows in one direction over the substrate surface.

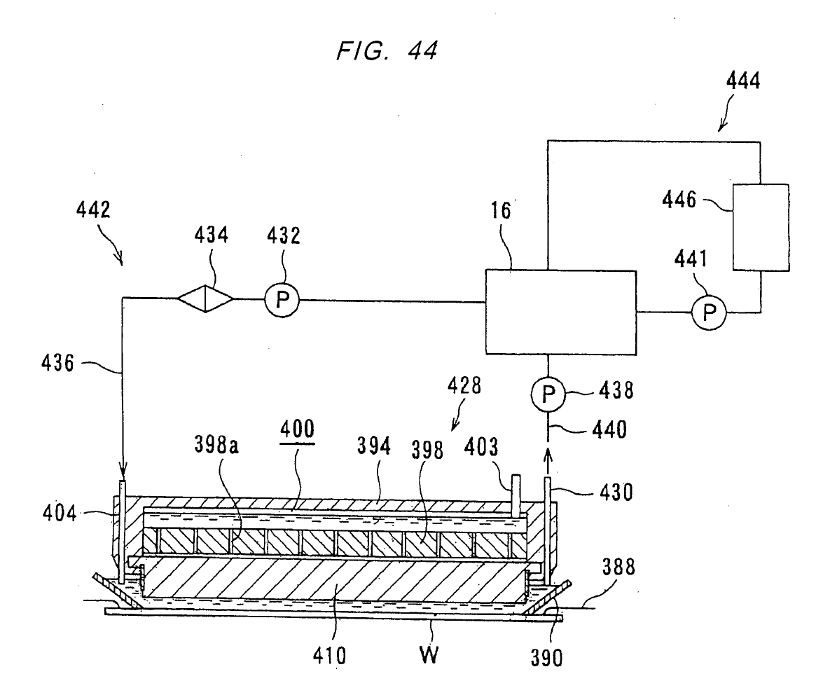

FIG. 44 shows an electrolytic processing apparatus, employed as an electroplating apparatus, according to yet another embodiment of the present invention. The electroplating apparatus adds the following construction to the electroplating apparatus of the above-described embodiment mainly shown in FIG. 33.

The electrode holder 394, on the opposite side of the substrate W from the plating solution injection section 404, is provided with a plating solution suction section 430, disposed beside the anode 398 and the porous structure 410, for sucking in the plating solution injected into the space between the substrate W and the porous structure 410. A plating solution supply line 436, having a delivery pump 432 and a filter 434 in it, is connected at one end to the plating tank 16 (see FIG. 5) and connected at the other end to the plating solution injection section 404. Further, a plating solution discharge line 440, having a suction pump 438 in it, is connected at one end to the plating solution tank 16 and connected at the other end to the plating solution suction section 430. A plating solution circulation system 442 is thus constructed in which by the actuation of the pumps 432, 438, the plating solution in the plating solution tank 16 is supplied into the space between the substrate W and the porous structure 410 and stored in the space defined by the substrate W and the sealing member 390 while the thus-stored plating solution is returned to the plating solution tank 16.

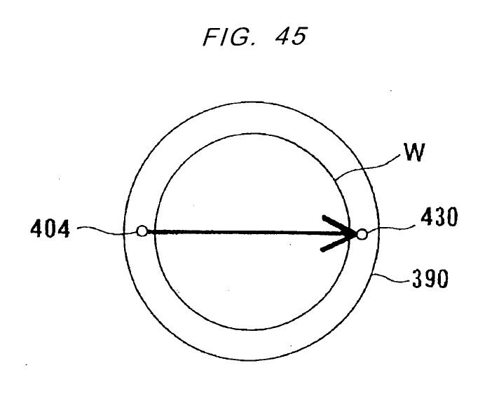

According to this embodiment, similarly to the above-described embodiments, when the substrate holder is in the plating position B (see FIG. 7), the electrode head 328 is lowered until the distance between the substrate W held by the substrate holder and the porous structure 410 becomes, for example, about 0.5 to 3 mm, and the plating solution is injected from the plating solution injection section 404 into the space between the substrate W and the porous structure 410. The injected plating solution fills the space and is stored in the space defined by the substrate W and the sealing member 390 while the plating solution is sucked in by the plating solution suction section 430. Plating of the surface (lower surface) of the substrate W is carried out while keeping the space between the substrate W and the porous structure 410 filled with the plating solution flowing in one direction, as shown in FIG. 45.

This embodiment can thus eliminate the need for provision of, for example, an electrolytic solution supply tube composed of an insulating material, which may disturb the electric field distribution, within the porous structure 410. This can make the electric field distribution uniform over the entire surface of a substrate W. Furthermore, the plating solution held in the porous structure 410 can be prevented from leaking out of the porous structure 410 upon the injection of plating solution. Further according to this embodiment, the plating solution is injected from the side of the porous structure 410 into the space between the substrate W held by the substrate holder and the porous structure 410, and the plating solution is allowed to circulate so that the plating solution constantly flows between the substrate W and the porous structure 410. This can prevent the formation of plating defects, i.e., non-plated portions, caused by a stop of the flow of plating solution during electroplating. Further, by rotating the substrate W according to necessity, the plating solution is allowed to flow at a more even speed over the central and peripheral regions of the substrate W.

The electroplating apparatus of this embodiment is further provided with a deaerator for removing dissolved gas from the plating solution circulated and used in the above-described manner. In particular, the plating solution tank 16 is provided with an auxiliary circulation line 444 for circulating the plating solution in the plating solution tank 16 by the actuation of a circulation pump 441, and a deaerator 446 is provided in the auxiliary circulation line 444. By thus circulating the plating solution while deaerating it with the deaerator 446 and using the deaerated plating solution in plating, dissolved gas in the plating solution can be prevented from becoming gas bubbles upon the injection of the plating solution and remaining in the plating solution.

This holds also for the plating solution injected into the space between a substrate and a porous structure and used in plating in the above-described embodiments.

Though in this embodiment the present apparatus is employed as a copper electroplating apparatus for carrying out copper plating, the present apparatus can also be used for electroplating of Cr, Mn, Fe, Co, Ni, Zn, Ga, Ru, Rh, Pd, Ag, Cd, In, Sn, Sb, Os, Ir, Pt, Au, Hg, Ti, Pb or Bi, or an alloy thereof.

According to this embodiment, the effect of the electric resistance (sheet resistance) of a surface conductive layer of a substrate can be reduced, thereby making the electric field more uniform over the entire surface of the substrate. Thus, in the case of an electroplating apparatus, a plated film having a high in-plane uniformity of thickness can be formed on a surface of a substrate (conductive layer) even when the substrate has a large area and a conductive layer, which is thin and has a large electric resistance, is formed on the surface.

What is claimed is:

1. A plating apparatus comprising:
a substrate holder for holding a substrate;
a cathode portion including a cathode for contact with the substrate held by the substrate holder to feed electricity to the substrate; and
an anode, partly or wholly having a high resistance, disposed opposite a surface of the substrate held by the substrate holder;
wherein plating of the surface of the substrate is carried out while filling between the anode and the substrate held by the substrate holder with a plating solution.

2. The plating apparatus according to claim 1, wherein the high resistance of part or the whole of the anode is set at the same level as the resistance of the anode-facing surface of the substrate held by the substrate holder.

3. The plating apparatus according to claim 1, wherein the high resistance of part or the whole of the anode is higher than the electric resistance of the plating solution.

4. The plating apparatus according to claim 1, wherein the high resistance of part or the whole of the anode is provided radially from the center of the anode.

5. The plating apparatus according to claim 1, wherein the part or the whole of the anode having the high resistance is composed of a material having a high resistivity.

6. The plating apparatus according to claim 1, wherein a thin metal film and/or a thin metal oxide film is provided on the substrate-facing surface of the anode which faces the surface of the substrate held by the substrate holder.

7. The plating apparatus according to claim 1, wherein a central contact, in contact with a feeding wire extending from a power source, for feeding electricity to the anode is provided in the center of the anode.

8. The plating apparatus according to claim 7, wherein a peripheral contact, in contact with a feeding wire, for feeding electricity to the anode is provided in the peripheral region of the anode continuously over the entire circumference.

9. The plating apparatus according to claim 8, wherein at least one intermediate contact, in contact with a feeding wire, for feeding electricity to the anode is provided between the central contact and the peripheral contact of the anode continuously over the entire circumference.

10. The plating apparatus according to claim 8, wherein the plating apparatus has plating power sources respectively for each of the feeding wires for feeding electricity to the anode.

11. The plating apparatus according to claim 8, wherein the plating apparatus has switches for on/off switching of electric current respectively for each of the feeding wires for feeding electricity to the anode.

12. The plating apparatus according to claim 1, wherein a plated film of copper is formed on the surface of the substrate.

13. A plating method comprising:
preparing a substrate having interconnect recesses covered with a barrier layer or a seed layer in a surface;
disposing an anode, partly or wholly having a high resistance, opposite the surface of the substrate;
filling between the substrate and the anode with a plating solution; and
carrying out plating by feeding electricity to the barrier layer or the seed layer from its peripheral region and feeding electricity to the anode from its center in the early stage of plating, and
carrying out plating by feeding electricity to the barrier layer or the seed layer from its peripheral region and feeding electricity to the anode from its peripheral region in the later stage of plating.

14. A plating apparatus comprising:
a substrate holder for holding a substrate;
a cathode portion including a cathode for contact with the substrate held by the substrate holder to feed electricity to the substrate;
an anode disposed opposite a surface of the substrate; and
a contact member disposed between the substrate held by the substrate holder and the anode movably in a direction closer to or away from the substrate, said contact member having through-holes extending linearly through the contact member in said movement direction.

15. The plating apparatus according to claim 14 further comprising a press mechanism for pressing a contact surface, which faces the surface of the substrate held by the substrate holder, of the contact member against the surface of the substrate.

16. The plating apparatus according to claim 14, wherein a press member for pressing the contact surface of the contact member against the surface of the substrate is disposed between the contact member and the anode.

17. The plating apparatus according to claim 14, wherein a flexible cushioning material for uniformly pressing the contact surface of the contact member against the surface of the substrate is disposed between the contact member and the anode.

18. The plating apparatus according to claim 14, wherein the through-holes provided in the contact member have a circular cross-sectional shape with a diameter of not more than 12 μm, and are distributed at a density of 1.0×10⁵ to 1.0×10⁹/cm².

19. The plating apparatus according to claim 14, wherein the contact surface of the contact member has an Ra value, indicative of surface roughness, of not more than 1 μm.

20. The plating apparatus according to claim 14, wherein the contact member is composed of an insulating material.

21. The plating apparatus according to claim 20, wherein the insulating material is polycarbonate, a ceramic, carbon, polyester, glass, silicon, a resist material or a fluorocarbon resin.

22. The plating apparatus according to claim 14 further comprising an etching mechanism for etching a plated film formed on the surface of the substrate.

23. The plating apparatus according to claim 14, wherein the through-holes provided in the contact member are tapered such that the cross-sectional area gradually decreases with distance from the contact surface.

24. A plating method comprising:
preparing a substrate having interconnect recesses formed in a surface;
disposing an anode opposite the surface of the substrate;
disposing a contact member, having linearly-extending through-holes, between the substrate and the anode such that a contact surface, which faces the surface of the substrate, of the contact member is in pressure contact with the surface of the substrate; and
carrying out plating of the surface of the substrate by passing a plating current between the anode and the surface of the substrate while filling between the anode and the substrate with a plating solution.

25. The plating method according to claim 24, wherein the plating of the surface of the substrate is carried out while keeping the contact member stationary with respect to the substrate.

26. The plating method according to claim 24, wherein after carrying out the plating of the surface of the substrate, the position of the contact surface of the contact member relative to the surface of the substrate is changed, and additional plating of the surface of the substrate is carried out.

27. The plating method according to claim 26, wherein the position of the contact surface of the contact member relative to the surface of the substrate is changed after separating the contact member from the surface of the substrate.

28. The plating method according to claim 26, wherein before carrying out the additional plating of the surface of the substrate, a plated film formed on the surface of the substrate is subjected to etching.

29. The plating method according to claim 28, wherein the etching is carried out by reversing the polarities in plating of the anode and the surface of the substrate while filling between the anode and the substrate with the plating solution.

30. The plating method according to claim 29, wherein the etching is carried out while keeping the contact member at a distance from the surface of the substrate.

31. A substrate processing method comprising:
carrying out plating of a substrate by the plating method according to claim 23; and then
polishing a surface of the substrate by a CMP apparatus, thereby removing an extra plated film present outside interconnect portions.

32. A substrate processing method comprising:
carrying out plating of a substrate by the plating method according to claim 23;
subsequently removing columnar portions on a surface of the substrate by an etching apparatus to flatten the surface; and then polishing the substrate surface by a CMP apparatus, thereby removing an extra plated film present outside interconnect portions.

33. A plated film comprising numerous columnar portions, obtained by a plating process comprising plating a surface of a substrate while keeping a contact member, having linearly-extending through-holes, in contact with a surface of the substrate to grow the columnar portions linearly along the through-holes.

34. The plated film according to claim 33, wherein the columnar portions are circular portions having a diameter of not more than 12 μm.

35. An electrolytic processing apparatus comprising:
a substrate holder for holding a substrate;
a first electrode for contact with a substrate to feed electricity to a surface of the substrate;
a second electrode disposed opposite the surface of the substrate held by the substrate holder;
a porous structure having a pressure loss of not less than 500 kPa, disposed between the substrate held by the substrate holder and the second electrode;
an electrolytic solution injection section for injecting an electrolytic solution into between the substrate held by the substrate holder and the second electrode; and
a power source for applying a voltage between the first electrode and the second electrode.

36. The electrolytic processing apparatus according to claim 35, wherein the porous structure has a pressure loss of not less than 1000 kPa.

37. The electrolytic processing apparatus according to claim 35, wherein the porous structure has a resistivity of not less than 1.0×10⁵ Ω·cm.

38. The electrolytic processing apparatus according to claim 35, wherein the porous structure is composed of silicon carbide, silicon carbide with oxidation-treated surface, alumina or a plastic, or a combination thereof.

39. The electrolytic processing apparatus according to claim 35, wherein the electric processing is electroplating of Cr, Mn, Fe, Co, Ni, Cu, Zn, Ga, Ru, Rh, Pd, Ag, Cd, In, Sn, Sb, Os, Ir, Pt, Au, Hg, Tl, Pb or Bi, or an alloy thereof, or electrolytic etching.

40. An electrolytic processing apparatus comprising:
a substrate holder for holding a substrate;
a first electrode for contact with a substrate to feed electricity to a surface of the substrate;
a second electrode disposed opposite the surface of the substrate held by the substrate holder;
a porous structure having an apparent porosity of not more than 19%, disposed between the substrate held by the substrate holder and the second electrode;
an electrolytic solution injection section for injecting an electrolytic solution into between the substrate held by the substrate holder and the second electrode; and
a power source for applying a voltage between the first electrode and the second electrode.

41. The electrolytic processing apparatus according to claim 40, wherein the apparent porosity of the porous structure is not more than 15%.

42. The electrolytic processing apparatus according to claim 40, wherein the porous structure has a resistivity of not less than 1.0×10⁵ Ω·cm.

43. The electrolytic processing apparatus according to claim 40, wherein the porous structure is composed of silicon carbide, silicon carbide with oxidation-treated surface, alumina or a plastic, or a combination thereof.

44. The electrolytic processing apparatus according to claim 40, wherein the electric processing is electroplating of Cr, Mn, Fe, Co, Ni, Cu, Zn, Ga, Ru, Rh, Pd, Ag, Cd, In, Sn, Sb, Os, Ir, Pt, Au, Hg, Tl, Pb or Bi, or an alloy thereof, or electrolytic etching.

45. An electrolytic processing apparatus comprising:
a substrate holder for holding a substrate;
a first electrode for contact with a substrate to feed electricity to a surface of the substrate;
a second electrode disposed opposite the surface of the substrate held by the substrate holder;
a porous structure, disposed between the substrate held by the substrate holder and the second electrode, having an overall electric resistance which is not less than 0.02 time the sheet resistance of a surface conductive layer of the substrate, said overall electric resistance being the electric resistance between the upper and lower surfaces of the porous structure with its interior filled with an electrolytic solution;
an electrolytic solution injection section for injecting the electrolytic solution into between the substrate held by the substrate holder and the second electrode; and
a power source for applying a voltage between the first electrode and the second electrode.

46. The electrolytic processing apparatus according to claim 45, wherein the porous structure has a resistivity of not less than 1.0×10⁵ Ω·cm.

47. The electrolytic processing apparatus according to claim 45, wherein the porous structure is composed of silicon carbide, silicon carbide with oxidation-treated surface, alumina or a plastic, or a combination thereof.

48. The electrolytic processing apparatus according to claim 45, wherein the electric processing is electroplating of Cr, Mn, Fe, Co, Ni, Cu, Zn, Ga, Ru, Rh, Pd, Ag, Cd, In, Sn, Sb, Os, Ir, Pt, Au, Hg, Tl, Pb or Bi, or an alloy thereof, or electrolytic etching.

49. An electrolytic processing method comprising:
filling between a surface of a substrate, in contact with a first electrode, and a second electrode disposed opposite the surface of the substrate with an electrolytic solution;
disposing in the electrolytic solution a porous structure of which the apparent porosity is adjusted to not more than 19%, or the pressure loss is adjusted to not less than 500 kPa, or at least one of the specific gravity and the water absorption is adjusted; and
applying a voltage between the first electrode and the second electrode.

50. The electrolytic processing method according to claim 49, wherein the apparent porosity of the porous structure, when it is adjusted to not more than 19%, is adjusted to not more than 15%.

51. The electrolytic processing method according to claim 49, wherein the pressure loss of the porous structure, when it is adjusted to not less than 500 kPa, is adjusted to not less than 1000 kPa.

52. The electrolytic processing method according to claim 49, wherein the porous structure has a resistivity of not less than 1.0×10⁵ Ω·cm.

53. The electrolytic processing method according to claim 49, wherein the porous structure is composed of silicon carbide, silicon carbide with oxidation-treated surface, alumina or a plastic, or a combination thereof.

54. The electrolytic processing method according to claim 49, wherein the electric processing is electroplating of Cr, Mn, Fe, Co, Ni, Cu, Zn, Ga, Ru, Rh, Pd, Ag, Cd, In, Sn, Sb, Os, Ir, Pt, Au, Hg, Tl, Pb or Bi, or an alloy thereof, or electrolytic etching.

55. An electrolytic processing method comprising:
filling between a surface of a substrate, in contact with a first electrode, and a second electrode disposed opposite the surface of the substrate with an electrolytic solution;
disposing in the electrolytic solution a porous structure of which the apparent porosity is adjusted to not more than 19%, or the overall electric resistance is adjusted to not less than 0.02 time the sheet resistance of a surface conductive layer of the substrate, said overall electric resistance being the electric resistance between the upper and lower surfaces of the porous structure with its interior filled with the electrolytic solution, or at least one of the specific gravity and the water absorption is adjusted; and
applying a voltage between the first electrode and the second electrode.

56. The electrolytic processing method according to claim 55, wherein the porous structure has a resistivity of not less than 1.0×10⁵ Ω·cm.

57. The electrolytic processing method according to claim 55, wherein the porous structure is composed of silicon carbide, silicon carbide with oxidation-treated surface, alumina or a plastic, or a combination thereof.

58. The electrolytic processing method according to claim 55, wherein the electric processing is electroplating of Cr, Mn, Fe, Co, Ni, Cu, Zn, Ga, Ru, Rh, Pd, Ag, Cd, In, Sn, Sb, Os, Ir, Pt, Au, Hg, Ti, Pb or Bi, or an alloy thereof, or electrolytic etching.
